(19) United States
(12) Patent Application Publication
(10) Pub. No.: US 2024/0162708 A1
(43) Pub. Date: May 16, 2024

(54) HYBRID POWER SYSTEMS FOR EQUIPMENT USED IN SUBTERRANEAN FIELD OPERATIONS

(71) Applicant: Chevron U.S.A. Inc., San Ramon, CA (US)

(72) Inventor: Tanis James Reed, Cypress, TX (US)

(21) Appl. No.: 18/503,615

(22) Filed: Nov. 7, 2023

Related U.S. Application Data
(60) Provisional application No. 63/425,612, filed on Nov. 15, 2022.

(51) Int. Cl. H02J 3/00; G05B 19/042; H02J 3/38; H02J 7/02

(52) U.S. Cl. CPC H02J 3/007; G05B 19/042; H02J 3/38; H02J 7/02; G05B 2219/15097

(57) ABSTRACT

A system for providing power to field equipment for subterranean field can include a utility power source that provides utility power having a setpoint value, a portable energy storage device module configured to provide reserve power, where the portable energy storage device module is mounted on a movable platform, an on-site substation that is configured to receive the utility power from the utility power source and the reserve power from the portable energy storage device module, and a controller configured to determine, at a time, that a demand level of the field equipment exceeds the setpoint value, control the portable energy storage device module to release the reserve power to the on-site substation, and control the on-site substation to deliver the utility power at the setpoint value and the reserve power at a remaining level to the field equipment.

### CROSS-REFERENCE TO RELATED APPLICATIONS

This application claims priority under 35 U.S.C. § 119 to U.S. Provisional Patent Application Ser. No. 63/425,612, titled “HYBRID POWER SYSTEMS FOR EQUIPMENT USED IN SUBTERRANEAN FIELD OPERATIONS” and filed on Nov. 15, 2022, the entire contents of which are hereby incorporated herein by reference.

### TECHNICAL FIELD

The present application is related to subterranean field operations and, more particularly, to hybrid power systems for equipment used in subterranean field operations.

### BACKGROUND

Rigs include various field equipment to perform one or more stages of a subterranean field operation. At times, the field equipment of these rigs are connected to and receive power from an electric power grid via transmission and/or distribution lines. Because the location of a rig can be fairly remote, the capacity of a transmission/distribution line that feeds electric power to the rig can be limited. When field equipment is operating in steady state, the limited amount of electric power delivered to a rig may be sufficient. However, because of the operating ratings and use of some of the equipment at a rig site, demand for electric power over relatively short periods of time (e.g., 5 minutes, 30 minutes) can spike above the capacity limitation of the transmission/distribution line feeding the rig. As a result, these spikes in peak demand can lead to outages and/or unreliable delivery of power that can affect the subterranean field operations.

### SUMMARY

In general, in one aspect, the disclosure relates to a system for providing power to field equipment for subterranean field operations. The system can include a utility power source that provides utility power, where the utility power has a setpoint value. The system can also include a portable energy storage device module configured to provide reserve power, where the portable energy storage device module is mounted on a movable platform. The system can further include an on-site substation that is configured to receive the utility power from the utility power source and the reserve power from the portable energy storage device module. The system can also include a controller operably coupled to the on-site substation and the portable energy storage device module. The controller can be configured to determine, at a time, that a demand level of the field equipment exceeds the setpoint value. The controller can also be configured to control the portable energy storage device module to release the reserve power to the on-site substation. The controller can further be configured to control the on-site substation to deliver the utility power at the setpoint value and the reserve power at a remaining level to the field equipment, where the setpoint value and the remaining level substantially equals the demand level of the field equipment.

In another aspect, the disclosure relates to an on-site substation for providing power to field equipment for subterranean field operations. The on-site substation can include a first channel configured to receive utility power from a utility power source. The on-site substation can also include a second channel configured to receive reserve power from a portable energy storage device module. The on-site substation can further include a third channel configured to deliver the utility power and the reserve power to the field equipment. The on-site substation can also include a controller that is configured to determine, at a time, that a demand level of the field equipment exceeds a setpoint value of the utility power. The controller can also be configured to limit the utility power to the setpoint value. The controller can further be configured to deliver the utility power at the setpoint value to the field equipment through the third channel. The controller can also be configured to control the portable energy storage device module to deliver the reserve power at a remaining level to the second channel, where the setpoint value and the remaining level substantially equals the demand level of the field equipment. The controller can further be configured to deliver the reserve power at the remaining level to the field equipment through the third channel.

In yet another aspect, the disclosure relates to a method for providing power to field equipment for subterranean field operations. The method can include determining, at a time, that a demand level of the field equipment exceeds a setpoint value of a utility generation source. The method can also include controlling a portable energy storage device module to release reserve power. The method can further include controlling an on-site substation to deliver utility power from the utility generation source at the setpoint value and the reserve power at a remaining level to the field equipment, where the setpoint value and the remaining level substantially equals the demand level of the field equipment.

These and other aspects, objects, features, and embodiments will be apparent from the following description and the appended claims.

### BRIEF DESCRIPTION OF THE DRAWINGS

The drawings illustrate only example embodiments and are therefore not to be considered limiting in scope, as the example embodiments may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles. In the drawings, reference numerals designate like or corresponding, but not necessarily identical, elements.

FIGS. 1 and 2 show field systems with which example embodiments can be used.

FIG. 3 shows a diagram of a system for a subterranean operation according to certain example embodiments.

FIG. 4 shows a system diagram of an on-site substation according to certain example embodiments.

FIG. 5 shows a system diagram of a controller according to certain example embodiments.

FIG. 6 shows a computing device in accordance with certain example embodiments.

FIGS. 7A through 7C show a flowchart of a method for hybrid power systems for equipment used in subterranean field operations according to certain example embodiments.

FIGS. 8 through 11 show power flow diagrams according to certain example embodiments.

FIG. 12 shows a schematic diagram of the portable energy storage device module of FIGS. 8 through 11 according to certain example embodiments.

FIG. 13 shows a schematic diagram of the on-site substation of FIGS. 8 through 11 according to certain example embodiments.

### DETAILED DESCRIPTION

The example embodiments discussed herein are directed to systems, apparatus, methods, and devices for hybrid power systems for equipment used in subterranean field operations. Example embodiments can be used for subterranean field operations that are based on land or off shore. Example embodiments are designed to reduce or “shave” peak demand of field equipment used on subterranean field operations so that utility power provided by utility power sources to a rig is not interrupted. Example embodiments can be scaled up or down to meet the needs of a particular rig. Example embodiments can work in conjunction with on-site generation that may exist with a rig. Example embodiments can be used during any stage of a field operation, including but not limited to exploration, production (e.g., enhanced oil recovery (EOR)), injection (e.g., salt water disposal (SWD), waterflooding), and fracturing.

Example embodiments can be designed to comply with certain standards and/or requirements. Examples of entities that set such standards and/or requirements can include, but are not limited to, the Society of Petroleum Engineers, the American Petroleum Institute (API), the International Standards Organization (ISO), the Institute of Electrical and Electronics Engineers (IEEE), and the Occupational Safety and Health Administration (OSHA). Each component of a hybrid power system (including portions thereof) can be made of one or more of a number of suitable materials, including but not limited to metal (e.g., stainless steel), ceramic, rubber, glass, fibrous material, and plastic.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein. By way of example, if an item is described herein as including a component of type A, a component of type B, a component of type C, or any combination thereof, it is understood that this phrase describes all of the various individual and collective combinations and permutations of these components. For example, in some embodiments, the item described by this phrase could include only a component of type A. In some embodiments, the item described by this phrase could include only a component of type B. In some embodiments, the item described by this phrase could include only a component of type C. In some embodiments, the item described by this phrase could include a component of type A and a component of type B. In some embodiments, the item described by this phrase could include a component of type A and a component of type C. In some embodiments, the item described by this phrase could include a component of type B and a component of type C. In some embodiments, the item described by this phrase could include a component of type A, a component of type B, and a component of type C. In some embodiments, the item described by this phrase could include two or more components of type A (e.g., A1 and A2). In some embodiments, the item described by this phrase could include two or more components of type B (e.g., B1 and B2). In some embodiments, the item described by this phrase could include two or more components of type C (e.g., C1 and C2). In some embodiments, the item described by this phrase could include two or more of a first component (e.g., two or more components of type A (A1 and A2)), optionally one or more of a second component (e.g., optionally one or more components of type B), and optionally one or more of a third component (e.g., optionally one or more components of type C). In some embodiments, the item described by this phrase could include two or more of a first component (e.g., two or more components of type B (B1 and B2)), optionally one or more of a second component (e.g., optionally one or more components of type A), and optionally one or more of a third component (e.g., optionally one or more components of type C). In some embodiments, the item described by this phrase could include two or more of a first component (e.g., two or more components of type C (C1 and C2)), optionally one or more of a second component (e.g., optionally one or more components of type A), and optionally one or more of a third component (e.g., optionally one or more components of type B).

If a component of a figure is described but not expressly shown or labeled in that figure, the label used for a corresponding component in another figure can be inferred to that component. Conversely, if a component in a figure is labeled but is not described, the description for such component can be substantially the same as the description for the corresponding component in another figure. The numbering scheme for the various components in the figures herein is such that each component is a three-digit number or a four-digit number, and corresponding components in other figures have the identical last two digits. For any figure shown and described herein, one or more of the components may be omitted, added, repeated, and/or substituted. Accordingly, embodiments shown in a particular figure should not be considered limited to the specific arrangements of components shown in such figure.

Further, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings is capable of being included in one or more claims that correspond to such one or more particular drawings herein.

Example embodiments of hybrid power systems for equipment used in subterranean field operations will be described more fully hereinafter with reference to the accompanying drawings, in which example embodiments of hybrid power systems for equipment used in subterranean field operations are shown. Hybrid power systems for equipment used in subterranean field operations may, however, be embodied in many different forms and should not be construed as limited to the example embodiments set forth herein. Rather, these example embodiments are provided so that this disclosure will be thorough and complete, and will fully convey the scope of hybrid power systems for equipment used in subterranean field operations to those of ordinary skill in the art. Like, but not necessarily the same, elements (also sometimes called components) in the various figures are denoted by like reference numerals for consistency.

Terms such as “first”, “second”, “primary,” “secondary,” “above”, “below”, “inner”, “outer”, “distal”, “proximal”, “end”, “top”, “bottom”, “upper”, “lower”, “side”, “left”, “right”, “front”, “rear”, and “within”, when present, are used merely to distinguish one component (or part of a component or state of a component) from another. This list of terms is not exclusive. Such terms are not meant to denote a preference or a particular orientation, and they are not meant to limit embodiments of hybrid power systems for equipment used in subterranean field operations. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

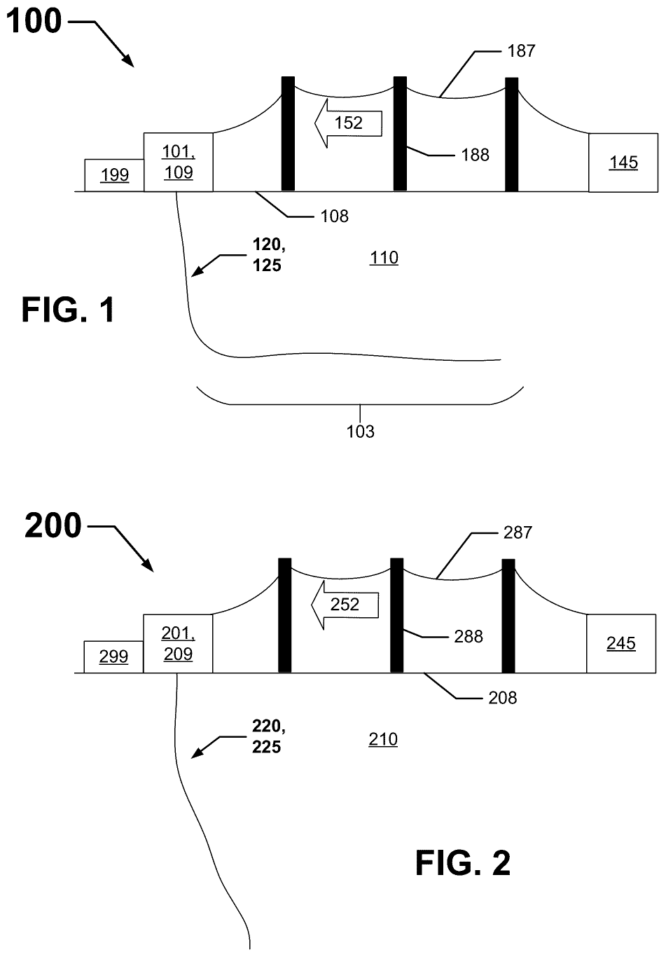

FIGS. 1 and 2 show field systems with which example embodiments can be used. Specifically, FIG. 1 shows a diagram of a land-based field system 100 in which a wellbore 120 has been drilled or is being drilled in a subterranean formation 110 and in which example embodiments can be used. FIG. 2 shows a diagram of another land-based field system 200 in which a wellbore 220 has been drilled or is being drilled in a subterranean formation 210 and in which example embodiments can be used. The field system 100 of FIG. 1 includes a wellbore 120 disposed in a subterranean formation 110 using field equipment 109 (e.g., a derrick, a tool pusher, a clamp, a tong, drill pipe, casing pipe, a drill bit, a wireline tool, a fluid pumping system, a motor, a variable frequency drive, a compressor, an energy transfer device (e.g., a transformer, an inverter, a converter)) located on or near a rig 101 located above a surface 108. In some cases, some of the field equipment 109 can be located within the wellbore 120.

The system 100 of FIG. 1 also includes one or more utility power sources 145 and an example hybrid power system 199. Each utility power source 145 generates and/or transmits power 152 (also called grid power 152 or utility power 152 herein) to the field equipment 109 on the rig 101. The utility power 152 is transmitted from a utility power source 145 to the field equipment 109 using one or more power transfer links 187. Each power transfer link 187 can include one or more electrical conductors, which can be individual or part of one or more electrical cables. Each power transfer link 187 can be sized (e.g., 12 gauge, 18 gauge, 4 gauge) in a manner suitable for the amount (e.g., 2.3 kV, 480V, 24V, 120V) and type (e.g., alternating current (AC), direct current (DC)) of utility power 152 transferred therethrough.

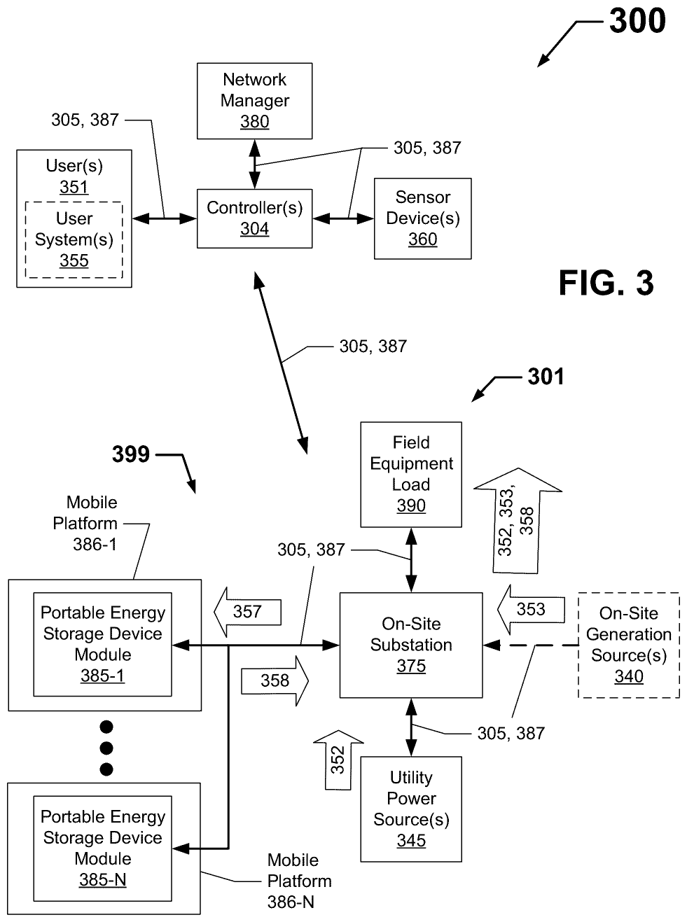

The power transfer links 187 can be or include transmission lines and/or distribution lines. The power transfer links 187 can be supported by an infrastructure 188 that can be or include multiple components, including but not limited to poles, towers, transformers, breakers, relays, switches, and controllers. The example hybrid power system 199 can include one or more portable energy storage device modules, each mounted on a mobile platform, and an on-site substation. More details as to these and other components of the example hybrid power system 199 are discussed below with respect to FIG. 3. The example hybrid power system 199 can be used to provide a partial amount of power at various times to the field equipment 109 in performing one or more stages (e.g., exploration, cementing, fracturing, production) of a field operation on the wellbore 120. For instance, the example hybrid power system 199 at times supplements utility power 152 provided by the utility power sources 145.

The wellbore 120 can be any of a number of types of wells (e.g., production wells, injection wells, sequestration wells). Also, in this case, the wellbore 120 has a vertical section and a horizontal section 103. The composition of the field equipment 109 of the system 199 can change based on the stage of the field operation. As a result, the demand (instantaneous usage) and consumption (cumulative usage over a period of time) of electricity can change, depending on the field equipment 109 used for a particular stage of a field operation. With respect to the system 199 of FIG. 1, once the wellbore 120 (or a portion thereof) is drilled, a casing string 125 is inserted into the wellbore 120 (at least to the extent drilled at that time) to stabilize the wellbore 120 and allow for the eventual extraction of subterranean resources (e.g., natural gas, oil, produced water) from the subterranean formation 110. Field equipment 109, located at the surface 108, is used to drill, encase, fracture, produce, and/or perform any other part of a field operation with respect to the wellbore 120. The wellbore 120 of FIG. 1 starts out as substantially vertical, and then has a substantially horizontal section 103. This configuration of the wellbore 120 is common for exploration and production of subterranean resources, such as oil and natural gas.

Similarly, the field system 200 of FIG. 2 includes a wellbore 220 disposed in a subterranean formation 210 using field equipment 209 (substantially the same as the field equipment 109 discussed above with respect to FIG. 1) located on or near a rig 201 located above a surface 208. In some cases, some of the field equipment 209 can be located within the wellbore 220. The system 200 of FIG. 2 also includes one or more utility power sources 245 and an example hybrid power system 299. Each utility power source 245 generates and/or transmits power 252 (also called grid power 252 or utility-power 252 herein) to the field equipment 209 on the rig 201. The utility power 252 is transmitted from a utility power source 245 to the field equipment 209 using one or more power transfer links 287 (substantially similar to the power transfer links 187 discussed above). The power transfer links 287 can be or include transmission lines and/or distribution lines. The power transfer links 287 can be supported by an infrastructure 288 that can be or include multiple components, including but not limited to poles, towers, transformers, breakers, relays, switches, and controllers. The example hybrid power system 299 can include one or more portable energy storage device modules, each mounted on a mobile platform, and an on-site substation.

With respect to the system 200 of FIG. 2, once the wellbore 220 (or portion thereof) is drilled, a casing string 225 is inserted into the wellbore 220 to stabilize the wellbore 220 from the subterranean formation 210. Field equipment 209, located at the surface 208, is used to drill, encase, fracture, produce, and/or perform any other part of a field operation with respect to the wellbore 220. The wellbore 220 of FIG. 2 is substantially vertical. This configuration of the wellbore 220 is common for injection wells.

Referring back to FIG. 1, the surface 108 can be ground level for an onshore application and the sea floor (or other similar floor under a body of water) for an offshore application. Similarly, the surface 208 of FIG. 2 can be ground level for an onshore application and the sea floor (or other similar floor under a body of water) for an offshore application. A body of water can include, but it not limited to, sea water, brackish water, flowback or produced water, wastewater (e.g., reclaimed or recycled), brine (e.g., reservoir or synthetic brine), fresh water (e.g., fresh water comprises <1,000 ppm TDS), any other type of water, or any combination thereof.

For offshore applications, at least some of the field equipment 109, 209 can be located on a platform that sits above the water level. The point where the wellbore 120, 220 begins at the surface 108, 208 can be called the wellhead. While not shown in FIG. 1 or 2, there can be multiple wellbores 120, 220, each with its own wellhead but that is located close to the other wellheads, drilled into the subterranean formation 110, 210 and having substantially vertical sections and/or horizontal sections 103 that are close to each other. In such a case, the multiple wellbores 120, 220 can be drilled at the same pad or at different pads.

During the process of drilling the wellbore 120 of FIG. 1, (and similarly for the wellbore 220 of FIG. 2), subterranean samples in the form of cuttings, produced water, and/or other subterranean resources (e.g., relatively small amounts of oil or natural gas) are extracted from downhole to the surface 108, where some of the field equipment 109 separates out at least some of the cuttings and recirculates the produced water back downhole. When the drilling process is complete, other operations, such as fracturing operations, can be performed. Throughout each of these various operations, fluids are circulated from the surface 108 by the field equipment 109, and subterranean samples are collected and tested for any of a number of parameters.

The subterranean formation 110 can include one or more of a number of formation types, including but not limited to shale, limestone, sandstone, clay, sand, and salt. In certain embodiments, a subterranean formation 110 can include one or more reservoirs in which one or more resources (e.g., oil, natural gas, water, steam) can be located. One or more of a number of field operations (e.g., fracturing, coring, tripping, drilling, setting casing, extracting downhole resources) can be performed to reach an objective of a user with respect to the subterranean formation 110.

The wellbore 120 of FIG. 1 (and similarly for the wellbore 220 of FIG. 2) can have one or more of a number of segments or hole sections, where each segment or hole section can have one or more of a number of dimensions. Examples of such dimensions can include, but are not limited to, a size (e.g., diameter) of the wellbore 120, a curvature of the wellbore 120, a total vertical depth of the wellbore 120, a measured depth of the wellbore 120, and a horizontal displacement of the wellbore 120. There can be multiple overlapping casing strings of various sizes (e.g., length, outer diameter) contained within and between these segments or hole sections to ensure the integrity of the wellbore construction. In this case, one or more of the segments of the subterranean wellbore 120 is the substantially horizontal section 103.

As discussed above, inserted into and disposed within the wellbore 120 of FIG. 1 are a number of casing pipes that are coupled to each other end-to-end to form the casing string 125. Similarly, inserted into and disposed within the wellbore 220 of FIG. 2 are a number of casing pipes that are coupled to each other end-to-end to form the casing string 225. In this case, each end of a casing pipe has mating threads (a type of coupling feature) disposed thereon, allowing a casing pipe to be directly or indirectly mechanically coupled to another casing pipe in an end-to-end configuration. The casing pipes of the casing string 125 and the casing string 225 can be indirectly mechanically coupled to each other using a coupling device, such as a coupling sleeve.

Each casing pipe of the casing string 125 and each casing pipe of the casing string 225 can have a length and a width (e.g., outer diameter). The length of a casing pipe can vary. For example, a common length of a casing pipe is approximately 40 feet. The length of a casing pipe can be longer (e.g., 60 feet) or shorter (e.g., 10 feet) than 40 feet. The width of a casing pipe can also vary and can depend on the cross-sectional shape of the casing pipe. For example, when the shape of the casing pipe is cylindrical, the width can refer to an outer diameter, an inner diameter, or some other form of measurement of the casing pipe. Examples of a width in terms of an outer diameter can include, but are not limited to, 4½ inches, 7 inches, 7⅝ inches, 8⅝ inches, 10¾ inches, 13⅜ inches, and 14 inches.

The size (e.g., width, length) of the casing string 125 and the casing string 225 can be based on the information (e.g., diameter of the borehole drilled) gathered using field equipment with respect to the subterranean wellbore 120 and the subterranean wellbore 220. The walls of the casing string 125 and the casing string 225 have an inner surface that forms a cavity that traverses the length of the casing string 125 and the casing string 225. Each casing pipe can be made of one or more of a number of suitable materials, including but not limited to steel. As part of a field operation using the field equipment 109, cement is pumped into the wellbore 120 and the wellbore 220 through the cavity and then forced upward between the outer surface of the casing string 125 and the wall of the subterranean wellbore 120 and between the outer surface of the casing string 225 and the wall of the subterranean wellbore 220. In some cases, a liner may additionally be used with, or alternatively be used in place of, some or all of the casing pipes.

FIG. 3 shows a diagram of a system 300 for subterranean field operations according to certain example embodiments. The system 300 of FIG. 3 includes one or more utility power sources 345, one or more optional on-site generation sources 340, a hybrid power system 399, field equipment load 390, one or more controllers 304, one or more sensor devices 360, one or more users 351 (including one or more optional user systems 355), and a network manager 380. The example hybrid power system 399 includes an on-site substation 375 and one or more portable energy storage device modules 385, where each portable energy storage device module 385 is mounted on its own mobile platform 386. The field equipment load 390 is the electrical load for field equipment (e.g., field equipment 109, field equipment 209) located on or near the rig 301 and used for a field operation at a point in time.

The components shown in FIG. 3 are not exhaustive, and in some embodiments, one or more of the components shown in FIG. 3 may not be included in the example system 300. Any component of the system 300 can be discrete or combined with one or more other components of the system 300. Also, one or more components of the system 300 can have different configurations. For example, one or more sensor devices 360 can be disposed within or disposed on other components (e.g., a portable energy storage device module 385, the on-site substation 375, the field equipment load 390). As another example, a controller 304, rather than being a stand-alone device, can be part of one or more other components (e.g., a portable energy storage device module 385, the on-site substation 375) of the system 300.

Referring to FIGS. 1 through 3, the rig 301 of the system 300 can be used to conduct field operations of one or more wellbores (e.g., wellbore 120, wellbore 220). When there are multiple wellbores, two or more wellbores can be from a common pad and/or from different pads. Also, when there are multiple wellbores, each wellbore can have characteristics (e.g., total depth, total vertical depth, total length, number of casing stages, size of each casing stage, subterranean formations that are traversed) that can be the same as or different than the characteristics of one or more of the other wellbores. The field equipment load 390 can apply to a field operation of a single well at a time or to field operations of multiple wells simultaneously.

The one or more utility power sources 345 can generate and/or otherwise provide utility power 352 to the rig 301 for use by the field equipment load 390 and/or the portable energy storage device modules 385. The utility power 352 provided by the utility power sources 345 is delivered to the on-site substation 375 of the hybrid power system 399 using power transfer links 387, where the on-site substation 375 processes and/or distributes the utility power 352 to one or more other components of the system 300. A utility power source 345 can be or include a generator, a transformer, transmission lines, distribution lines, meters, transformers, protective relays, one or more controllers (e.g., controllers 304), one or more sensor devices (e.g., sensor devices 360), arresters, breakers, and/or other similar components.

In some cases, the utility power 352 delivered by the utility power sources 345 at a point in time is limited (e.g., 2.3 MW, 1.5 MW, 3.1 MW). Such limitations can be a function of one or more of a number of factors. Such factors can include, but are not limited to, ambient temperature near the rig 301, humidity near the rig 301, nameplate capacity of a transformer, power factor, size of distribution lines, material of distribution lines, and distance of distribution lines to reach the rig 301. The limit of the utility power 352 that can be delivered to the rig 301 can be within a range of values that change as conditions (e.g., weather conditions) change at or near the rig 301.

As discussed above, the field equipment load 390 represents the electrical consumption of the field equipment (e.g., field equipment 109, field equipment 209). The field equipment load 390 can be represented in terms of demand (e.g., instantaneous usage in terms of MW or kW), usage (e.g., in terms of kWhs, in terms of MWhs) over a period of time (e.g., a month, a day), and/or any other designation of power. The power used by the field equipment load 390 is delivered by the on-site substation 375 using power transfer links 387. The on-site substation 375, discussed below, provides an amount of power that substantially matches the instantaneous demand of the field equipment load 390 in real time.

The demand of the field equipment load 390 can fluctuate within a relatively wide range (e.g., between 0 kW and 3700 kW), and at a relatively fast rate of change (e.g., 300 kW/s-500 kW/s), and some of the demand levels of the field equipment load 390 can exceed the maximum level (also called the setpoint value herein) of utility power 352 that the utility power sources 345 can reliably deliver to the rig 301. In such cases, the example hybrid power system 399 is configured to contribute an amount of power that is substantially equal to the difference between the demand of the field equipment load 390 and the maximum level of utility power 352 until such time as the demand of the field equipment load 390 falls below the maximum level of utility power 352.

The optional one or more on-site generation sources 340 are configured to generate on-site power 353, which is delivered to the on-site substation 375 using power transfer links 387. Each on-site generation source 340 can generate power using a fuel source (e.g., natural gas, methane, propane, steam, diesel fuel). Each on-site generation source 340 can generate a maximum amount (e.g., 0.9 MW, 500 kW, 1.5 MW) of on-site power 353. In some cases, an on-site generation source 340 can have load-following capability or be controlled to follow fluctuations in the demand of the field equipment load 390. The on-site power 353 delivered to the on-site substation 375 by an on-site generation source 340 can be processed and/or delivered to the field equipment load 390 and/or one or more of the portable energy storage device modules 385 at a particular point in time. An on-site generation source 340 can be dependent upon the on-site substation 375 for generator protection when both the on-site generation source 340 and the utility power source 345 are tied together, through the on-site substation 375.

An on-site generation source 340 can include one or more of a number of components. Examples of such components can include, but are not limited to, a generator, a transformer, an inverter, a breaker, a protective relay, a control relay, a controller (e.g., controller 304), a sensor device (e.g., sensor device 360), a fan, a switch, an exciter, and an energy transfer device (e.g., a transformer, an inverter, a converter). When the system 300 has multiple on-site generation sources 340, one on-site generation source 340 can be configured (e.g., nameplate capacity, fuel used, ramp rate) the same as, or differently than, one or more of the other on-site generation sources 340. Also, when the system 300 has multiple on-site generation sources 340, one on-site generation source 340 can be started, stopped, operated, and/or otherwise controlled independently of one or more of the other on-site generation sources 340.

As discussed above, the example hybrid power system 399 includes the on-site substation 375 and the one or more portable energy storage device modules 385. The on-site substation 375 is configured to receive power (e.g., utility power 352, on-site power 353, reserve power 358) from one or more components (e.g., a utility power source 345, an on-site generation source 340, a portable energy storage device module 385) of the system 300. For example, the on-site substation 375 can receive utility power 352 from a utility power source 345. As another example, the on-site substation 375 can receive on-site power 353 from an on-site generation source 340. As yet another example, the on-site substation 375 is configured to receive reserve power 358 from a portable energy storage device module 385.

In some cases, the on-site substation 375 is also configured to manipulate (e.g., transform, invert, convert) power that it receives. For example, the on-site substation 375 can transform utility power 352 into charging power 357. The on-site substation 375 is further configured to distribute power to another component of the system 300. For example, the on-site substation 375 can distribute utility power 352, on-site power 353, and/or reserve power 358 to the field equipment load 390. As another example, the on-site substation 375 can distribute charging power 357 to one or more of the portable energy storage device module 385.

In certain example embodiments, the on-site substation 375 is also configured to determine, in real time, the amount of utility power 352 received from the utility power sources 345, the amount of on-site power 353 received from the on-site generation sources 340, and the amount of reserve power 358 received from the portable energy storage device modules 385. Similarly, the on-site substation 375 is further configured to determine, in real time, the amount of demand of the field equipment load 390.

In certain example embodiment, the on-site substation 375 can control, in real time, the amount of utility power 352 provided by the utility power sources 345, the amount of on-site power 353 provided by the on-site generation sources 340, and/or the amount of reserve power 358 provided by the portable energy storage device modules 385. Similarly, the on-site substation 375 is further configured to control, in real time, the demand of the field equipment load 390 by identifying and controlling non-critical portions of the field equipment load 390 (e.g., using power calculations for Contingency-Based Load-Shedding techniques, using Under-Frequency Load-Shedding techniques, using power-limiting commands sent to the non-critical portions of the field equipment load 390). In this way, the on-site substation 375 of the example hybrid power system 399 can dynamically deliver reserve power 358 to complement utility power 352 and/or on-site power 353 to the field equipment load 390 when the demand of the field equipment load 390 exceeds the maximum level that the utility power sources 345 can safely and reliably deliver.

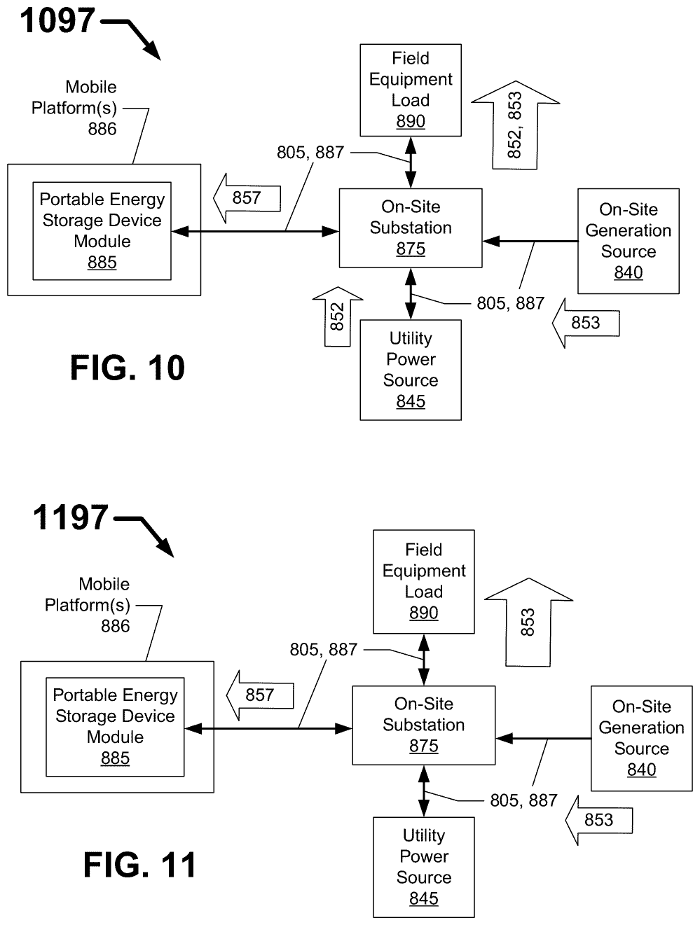

The on-site substation 375 can include one or more of a number of components. Examples of such components can include, but are not limited to, a transformer, an inverter, a breaker, a protective relay, a control relay, a controller (e.g., controller 304), a sensor device (e.g., sensor device 360), a fan, a switch, a contactor, and an arrester. The components of the on-site substation 375 can be centrally located (e.g., within an enclosure) or located in multiple locations with communication therebetween. A schematic of an example of an on-site substation 375 is shown in FIG. 12 below.

The example hybrid power system 399 can include any of a number (e.g., 1, 2, 5, 10) of portable energy storage device modules 385. In this case, there are N portable energy storage device modules 385 (portable energy storage device module 385-1 through portable energy storage device module 385-N). Each portable energy storage device module 385 is mounted on a mobile platform 386. In this case, there is one mobile platform 386 for every portable energy storage device module 385 (e.g., portable energy storage device module 385-1 is mounted on mobile platform 386-1, portable energy storage device module 385-N is mounted on mobile platform 386-N). In alternative embodiments, multiple portable energy storage device modules 385 can be mounted on a single mobile platform 386.

A mobile platform 386 can take on any of a number of configurations. For example, a mobile platform 386 can be a skid. As another example, a mobile platform 386 can be a wheeled trailer. As yet another example, a mobile platform 386 can be a frame. Each mobile platform 386 is designed to be picked up, positioned, transported, and/or otherwise moved using standard equipment (e.g., a forklift, a truck, a tractor). Mobile platforms 386 can be stand-alone or modular (e.g., stackable, horizontally connectable). When the system 300 has multiple mobile platforms 386, one mobile platform 386 can be configured the same as, or differently relative to, one or more of the other mobile platforms 386. In certain example embodiments, a mobile platform 386 can comply with one or more applicable standards and/or regulations (e.g., Department of Transportation 38.3).

A portable energy storage device module 385 of the system 300 can be configured to receive energy directly from the on-site substation 375. For example, in this case, each portable energy storage device module 385 receives charging power 357 from the on-site substation 375, where the charging power 357 can originate as utility power 352 from the utility power sources 345 and/or as on-site power 353 from the on-site generation sources 340.

A portable energy storage device module 385 can also be configured to store the energy that it receives. A portable energy storage device module 385 includes one or more of a number of energy storage devices, which are used to store the energy received by the portable energy storage device module 385. Examples of an energy storage device can include, but are not limited to, a battery (e.g., fixed, rechargeable, nickel cadmium, lithium ion, nickel metal hydride), a super capacitor, a fuel cell, a flywheel, and/or any other suitable device capable of storing some amount of energy. Each portable energy device module 385, or the collective of portable energy device modules 385 when the system 300 includes multiples of them, can have a sufficient quantity of energy storage devices so that the maximum draw of reserve power 358 can be achieved for the amount of time needed to meet the supplemental demand without allowing the energy storage devices to discharge below a minimum discharge value.

A portable energy storage device module 385 can further be configured to subsequently release the stored energy (e.g., reserve power 358) to the on-site substation 375 for use by the field equipment load 390. Each portable energy storage device module 385 can include one or more of a number of components. Such components can include, but are not limited to, an energy storage device, a transformer, an inverter, a breaker, a protective relay, a control relay, a controller (e.g., controller 304), a sensor device (e.g., sensor device 360), a fan, a switch, and a contactor. In certain example embodiments, the energy storage devices of a portable energy storage device module 385 can charge relatively quickly and discharge large amounts of power (e.g., more than 1 MW) for periods of time (e.g., 10 minutes, 30 minutes) that the peak of the field equipment load 390 can continuously exceed the utility setpoint value.

Depending on the technology (e.g., battery) used for the energy storage devices of a portable energy storage device module 385, the energy storage devices can have a maximum storage level beyond which additional charging power 357 cannot be received or can only be received at a reduced amount. Similarly, such energy storage devices of a portable energy storage device module 385 can have a minimum storage level (also called a minimum charge threshold level) below which the energy storage devices are unable to provide reserve power 358 without first receiving charging power 357.

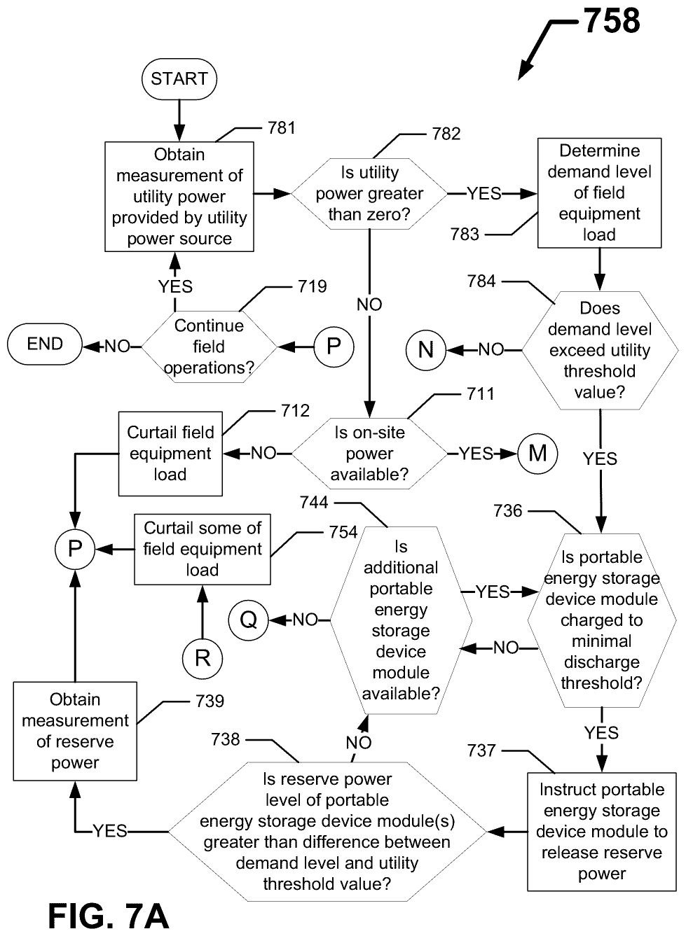

As discussed above, the system 300 can include one or more controllers 304. A controller 304 of the system 300 communicates with and in some cases controls one or more of the other components (e.g., a sensor device 360, the network manager 380, the hybrid energy storage system 399, the field equipment load 390) of the system 300. A controller 304 performs any of a number of functions that include obtaining and sending data, evaluating data, following protocols, running algorithms, and sending commands. A controller 304 can include one or more of a number of components. As discussed below with respect to FIG. 5, such components of a controller 304 can include, but are not limited to, a control engine, a data organization module, an analysis module, a communication module, a timer, a counter, a power module, a storage repository, a hardware processor, memory, a transceiver, an application interface, and a security module.

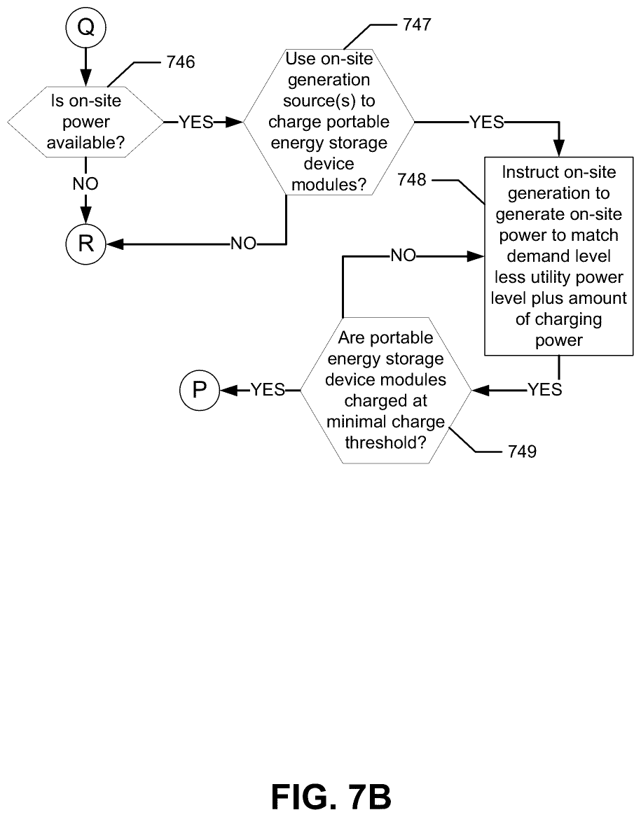

When there are multiple controllers 304 (e.g., one controller 304 for one or more portable energy storage device modules 385, another controller 304 for the on-site substation 375, yet another controller 304 for the on-site generation sources 340, still another one or more controllers 304 for the field equipment load 390) in the system 300, each controller 304 can operate independently of each other. Alternatively, two or more of the multiple controllers 304 can work cooperatively with each other. As yet another alternative, one of the controllers 304 can control some or all of one or more other controllers 304 in the system 300. Each controller 304 can be considered a type of computer device, as discussed below with respect to FIG. 6.

Each sensor device 360 includes one or more sensors that measure one or more parameters (e.g., temperature, humidity, voltage, current, storage level, electrical demand, electrical usage). Examples of a sensor of a sensor device 360 can include, but are not limited to, a temperature sensor, an ammeter, a voltmeter, a humidity sensor, and a camera. A sensor device 360 can measure a parameter in real time instantaneously over a period of time (e.g., an hour, a day, a year). A sensor device 360 can measure a parameter based on instructions from a user 351, based on the occurrence of an event (e.g., a passage of time, a change in demand of the field equipment load 390), and/or based on some other factor.

A sensor device 360 can be used with respect to the power transfer links 387, the communication links 305, field equipment load 390, the on-site generation sources 340, the utility power sources 345, the on-site substation 375, and/or the portable energy storage device modules 385. In some cases, a number of sensor devices 360, each measuring a different parameter, can be used in combination to determine and confirm whether a controller 304 should take a particular action (e.g., charge one or more of the portable energy storage device modules 385, release reserve power from one or more of the portable energy storage device modules 385). When a sensor device 360 includes its own controller 304 (or portions thereof), then the sensor device 360 can be considered a type of computer device, as discussed below with respect to FIG. 6.

A user 351 can be any person that interacts, directly or indirectly, with the network manager 380, a controller 304, a sensor device 360, the portable energy storage device modules 385, the on-site substation 375, the utility power sources 345, the field equipment load 390, the on-site generation sources 340, and/or any other component of the system 300. Examples of a user 351 may include, but are not limited to, a business owner, an engineer, a company representative, a field operator, a geologist, a consultant, a drilling engineer, a contractor, and a manufacturer's representative. A user 351 can use one or more user systems 355, which may include a display (e.g., a GUI). A user system 355 of a user 351 can interact with (e.g., send data to, obtain data from) the controller 304 via an application interface and using the communication links 305. The user 351 can also interact directly with the controller 304 through a user interface (e.g., keyboard, mouse, touchscreen).

The network manager 380 is a device or component that controls all or a portion (e.g., the example hybrid power system 399, a controller 304) of the system 300. The network manager 380 can be substantially similar to the controller 304, as described above. For example, the network manager 380 can include a controller that has one or more components and/or similar functionality to some or all of the controller 304. Alternatively, the network manager 380 can include one or more of a number of features in addition to, or altered from, the features of the controller 304. As described herein, control and/or communication with the network manager 380 can include communicating with one or more other components of the same system 300 or another system. In such a case, the network manager 380 can facilitate such control and/or communication. The network manager 380 can be called by other names, including but not limited to a master controller, a network controller, a gateway, and an enterprise manager. The network manager 380 can be considered a type of computer device, as discussed below with respect to FIG. 6.

Interaction between each controller 304, the sensor devices 360, the users 351 (including any associated user systems 355), the network manager 380, and other components (e.g., the portable energy storage device modules 385, the on-site substation 375, the utility power sources 345, the field equipment load 390, the on-site generation sources 340) of the system 300 can be conducted using communication links 305 and/or power transfer links 387. Each communication link 305 can include wired (e.g., Class 1 electrical cables, Class 2 electrical cables, electrical connectors, Power Line Carrier, RS485) and/or wireless (e.g., Wi-Fi, Zigbee, visible light communication, cellular networking, Bluetooth, Bluetooth Low Energy (BLE), ultrawide band (UWB), WirelessHART, ISA100) technology. A communication link 305 can transmit signals (e.g., communication signals, control signals, data) between each controller 304, the sensor devices 360, the users 351 (including any associated user systems 355), the network manager 380, and the other components of the system 300.

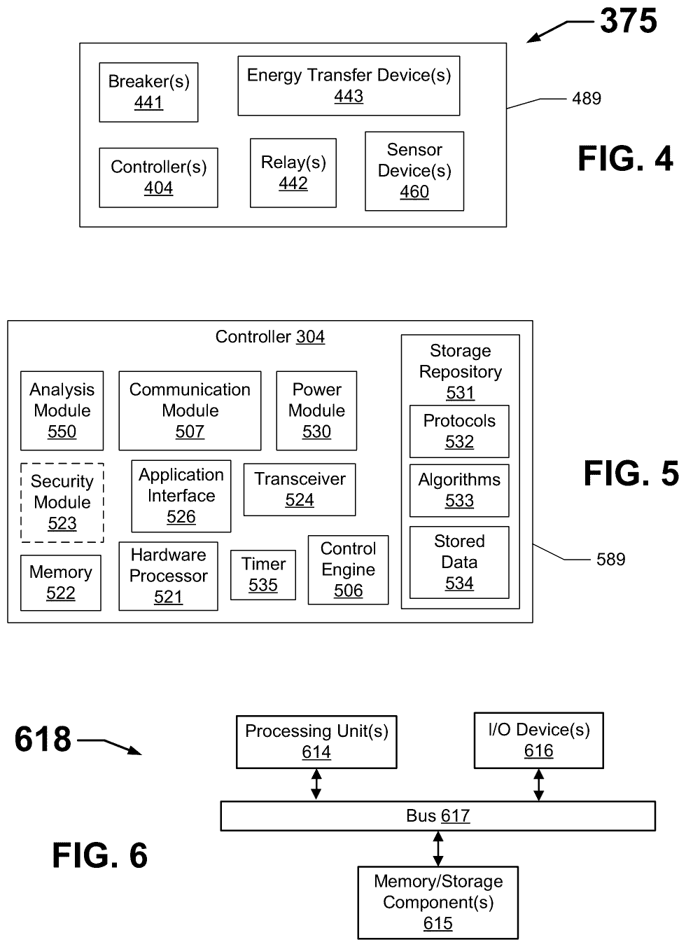

The power transfer links 387 can be substantially the same as the power transfer links 187 and the power transfer links 287 discussed above. FIG. 4 shows a system diagram of an on-site substation 375 according to certain example embodiments. Referring to FIGS. 1 through 4, the on-site substation 375 can be an example of the on-site substation 375 discussed above with respect to FIG. 3. The on-site substation 375 includes multiple components. In this case, the on-site substation 375 of FIG. 4 includes one or more controllers 404, one or more breakers 441, one or more relays 442, one or more energy transfer devices 443, and one or more sensor devices 460. The on-site substation 375 can include additional components (e.g., a fan, a compressor, a motor, a valve) not shown in FIG. 4 but known to those of ordinary skill in the art. The one or more controllers 404 and the one or more sensor devices 460 can be substantially the same as the controllers 304 and the sensor devices 360 discussed above with respect to FIG. 3.

A breaker 441 (also sometimes referred to as a circuit breaker 441 or an electrical breaker 441 herein) of the on-site substation 375 is an electrical safety device designed to protect downstream electrical equipment from an electrical fault (e.g., an overcurrent, an overvoltage, a short circuit). Specifically, when an electrical fault occurs, the breaker 441 detects the electrical fault and opens from its closed position, physically cutting off the flow of electrical power to the downstream equipment. A breaker 441 can be designed to operate at any suitable voltage level (e.g., 120V, 480V, 2.3 kV, 4 kV) that exists at the part of the electrical circuit in which the breaker 441 is inserted. A breaker 441 can operate in a DC circuit or an AC circuit. A breaker 441 can be any type of circuit breaker, including but not limited to solid state, magnetic, thermal-magnetic, common trip, shunt trip. A breaker 441 can be used to protect a single phase or legs. Alternatively, a breaker 441 can be used to protect multiple phases or legs.

A relay 442 (also sometimes referred to as an electrical relay 442 herein) of the on-site substation 375 is an electrically operated switch. A relay 442 is configured to monitor a portion of the on-site substation 375. A relay 442 can be a protective relay or a control relay. When the relay 442 is a protective relay, the relay 442 detects a particular anomaly that arises in the electrical circuit and directly or indirectly isolates a part of the on-site substation 375 (including components of the system 300 located downstream). When a relay 442 is a control relay, the relay 442 changes the operating state of one or more components of the on-site substation 375 (including components of the system 300 located downstream) when certain conditions occur. A relay 442 can work in conjunction with one or more breakers 441, where the relay 442 can serve to operate the breaker 441.

An energy transfer device 443 of the on-site substation 375 can manipulate power (e.g., utility power 352, on-site power 353, charging power 357, reserve power 358) in some way. An energy transfer device 443 can manipulate power by, for example, transforming the power (e.g., stepping the power up, stepping the power down), inverting the power, and/or converting the power. An energy transfer device 443 can be or include a transformer, an inverter, a converter, a diode, an inductor, a capacitor, and/or any other suitable component. The purpose of an energy transfer device 443 can be to have power delivered to a downstream component of the system 300 be of a type (e.g., AC, DC) and level (e.g., 24V, 120V, 480V) used by the downstream component.

When the energy transfer device 443 is of the on-site substation 375 is or includes an inverter, the inverter (as well as any breakers 441, any cables (e.g., of the power transfer links 387), and/or any other suitable equipment) needs to be sized to provide all of the supplemental power (i.e., the peak demand of the field equipment load 390 less the maximum level of utility power 352 that can be provided by the utility power sources 345) needed for the maximum peak demand.

The on-site substation 375 can include a housing 489. The housing 489 can include at least one wall that forms a cavity. In some cases, the housing 489 can be designed to comply with any applicable standards so that the on-site substation 375 can be located in a particular environment. The housing 489 of the on-site substation 375 can be used to house one or more components of the on-site substation 375. In alternative embodiments, any one or more of these or other components of the on-site substation 375 can be disposed on the housing 489 and/or remotely from the housing 489. For instance, one or more sensor devices 360 of the on-site substation 375 can be disposed on or remotely from the housing 489 of the on-site substation 375.

In certain example embodiments, the on-site substation 375 can be located on a mobile platform (e.g., a skid, a trailer, a flatbed) similar to the mobile platform 386 discussed above. In such cases, the mobile platform for the on-site substation 375 can be designed to meet applicable mechanical requirements. A mobile platform for the on-site substation 375 can help with replacement and/or modularity (e.g., as with field operations involving multiple wells on a pad or multiple pads).

FIG. 5 shows a system diagram of a controller 304 according to certain example embodiments. Referring to FIGS. 1 through 5, the controller 304 can be one of the controllers 304 discussed above with respect to FIG. 3. The controller 304 includes multiple components. In this case, the controller 304 of FIG. 5 includes a control engine 506, an analysis module 550, a communication module 507, a timer 535, a power module 530, a storage repository 531, a hardware processor 521, a memory 522, a transceiver 524, an application interface 526, and, optionally, a security module 523. A controller 304 (or components thereof) can be located at or near the various components of the system 300. In addition, or in the alternative, the controller 304 (or components thereof) can be located remotely from (e.g., in the cloud, at an office building) the various components of the system 300.

The controller 304 can include a housing 589. The housing 589 can include at least one wall that forms a cavity. In some cases, the housing 589 can be designed to comply with any applicable standards so that the controller 304 can be located in a particular environment. The housing 589 of the controller 304 can be used to house one or more components of the controller 304. In alternative embodiments, any one or more of these or other components of the controller 304 can be disposed on the housing 589 and/or remotely from the housing 589. For instance, the transceiver 524 of the controller 304 can include an antenna that is disposed on the housing 589. As another example, part of the storage repository 531 of the controller 304 can be located remotely from the housing 589 of the controller 304.

The storage repository 531 can be a persistent storage device (or set of devices) that stores software and data used to assist the controller 304 in communicating with one or more other components of a system, such as the users 351 (including associated user systems 355), each of the portable energy storage device modules 385, the on-site substation 375, the utility power sources 345, the field equipment load 390, the on-site generation sources 340, the network manager 380, the sensor devices 360, etc. of the system 300 of FIG. 3 above. In one or more example embodiments, the storage repository 531 stores one or more protocols 532, one or more algorithms 533, and stored data 534.

The protocols 532 of the storage repository 531 can be any procedures (e.g., a series of method steps) and/or other similar operational processes that the control engine 506 of the controller 304 follows based on certain conditions at a point in time. The protocols 532 can include any of a number of communication protocols that are used to send and/or obtain data between the controller 304 and other components of a system (e.g., the system 300). Such protocols 532 used for communication can be time-synchronized protocols. Examples of such time-synchronized protocols can include, but are not limited to, a highway addressable remote transducer (HART) protocol, a wirelessHART protocol, and an International Society of Automation (ISA) 100 protocol. In this way, one or more of the protocols 532 can provide a layer of security to the data transferred within a system (e.g., the system 300). Other protocols 532 used for communication can be associated with the use of Wi-Fi, Zigbee, visible light communication (VLC), cellular networking, BLE, UWB, and Bluetooth.

The algorithms 533 can be any formulas, mathematical models, forecasts, simulations, and/or other similar tools that the control engine 506 of the controller 304 uses to reach a computational conclusion. For example, one or more algorithms 533 can be used, in conjunction with one or more protocols 532, to assist the controller 304 to determine when to start, adjust, and/or stop the operation of the portable energy storage device modules 385, the on-site substation 375, the utility power sources 345, the field equipment load 390, and/or the on-site generation sources 340. For example, one or more algorithms 533 and one or more protocols 532, in conjunction with measurements made by one or more sensor devices 360, can be used to assist the controller 304 in determining when to send charging power 357 to one or more of the portable energy storage device modules 385, and which component (e.g., the utility power source 345, an on-site generation source 340) should originate the power (e.g., utility power 352, on-site power 353) that the on-site substation 375 uses to create the charging power 357.

Further, one or more algorithms 533 and one or more protocols 532, in conjunction with measurements made by one or more sensor devices 360, can be used to assist the controller 304 in determining when to stop sending charging power 357 to one or more of the portable energy storage device modules 385. Also, one or more algorithms 533 and one or more protocols 532, in conjunction with measurements made by one or more sensor devices 360, can be used to assist the controller 304 in determining when to send reserve power 358 and how much reserve power 358 to send from one or more of the portable energy storage device modules 385 to the field equipment load 390.

Further, one or more algorithms 533 and one or more protocols 532, in conjunction with measurements made by one or more sensor devices 360, can be used to assist the controller 304 in determining when to stop sending reserve power 358 from one or more of the portable energy storage device modules 385 to the field equipment load 390. As another example, one or more algorithms 533 can be used, in conjunction with one or more protocols 532, to assist the controller 304 to determine when to have a sensor device 360 measure a parameter and subsequently perform a calculation or make a determination using the measurement.

As yet another example, one or more algorithms 533 can be used, in conjunction with one or more protocols 532 and measurements made by one or more of the sensor devices 360, to assist the controller 304 to determine the utility power setpoint value, which is the maximum amount of power that the utility power sources 345 can deliver to the on-site substation 375 at any point in time. Further, one or more algorithms 533 can be used, in conjunction with one or more protocols 532 and measurements made by one or more of the sensor devices 360, to assist the controller 304 to establish and implement a control loop in having supplemental energy (e.g., reserve power 358) meet the peak demand of the field equipment load 390. The utility power setpoint value can be set high enough to allow for sufficient time for the energy storage devices of the portable energy storage device modules 385 to recharge, but not so high that the utility power sources 345 trip and/or otherwise go offline.

Stored data 534 can be any data associated with a field operation, nameplate data for components (e.g., the portable energy storage device modules 385, the on-site substation 375, the utility power sources 345, the field equipment load 390, the on-site generation sources 340), including portions thereof, of the system 300, data associated with a wellbore (e.g., wellbore 120, wellbore 220), measurements made by the sensor devices 360, threshold values, tables, results of previously run or calculated algorithms 533, updates to protocols 532, user preferences, the utility power setpoint value, and/or any other suitable data. Such data can be any type of data, including but not limited to historical data, present data, and future data (e.g., forecasts). The stored data 534 can be associated with some measurement of time derived, for example, from the timer 535.

Examples of a storage repository 531 can include, but are not limited to, a database (or a number of databases), a file system, cloud-based storage, a hard drive, flash memory, some other form of solid-state data storage, or any suitable combination thereof. The storage repository 531 can be located on multiple physical machines, each storing all or a portion of the communication protocols 532, the algorithms 533, and/or the stored data 534 according to some example embodiments. Each storage unit or device can be physically located in the same or in a different geographic location.

The storage repository 531 can be operatively connected to the control engine 506. In one or more example embodiments, the control engine 506 includes functionality to communicate with the users 351 (including associated user systems 355), the sensor devices 360, the network manager 380, and the other components in the system 300. More specifically, the control engine 506 sends information to and/or obtains information from the storage repository 531 in order to communicate with the users 351 (including associated user systems 355), the sensor devices 360, the network manager 380, and the other components of the system 300. As discussed below, the storage repository 531 can also be operatively connected to the communication module 507 in certain example embodiments.

In certain example embodiments, the control engine 506 of the controller 304 controls the operation of one or more components (e.g., the communication module 507, the timer 535, the transceiver 524) of the controller 304. For example, the control engine 506 can activate the communication module 507 when the communication module 507 is in “sleep” mode and when the communication module 507 is needed to send data obtained from another component (e.g., a sensor device 360) in the system 300. In addition, the control engine 506 of the controller 304 can control the operation of one or more other components (e.g., the portable energy storage device modules 385, the on-site substation 375, the utility power sources 345, the field equipment load 390, the on-site generation sources 340), or portions thereof, of the system 300.

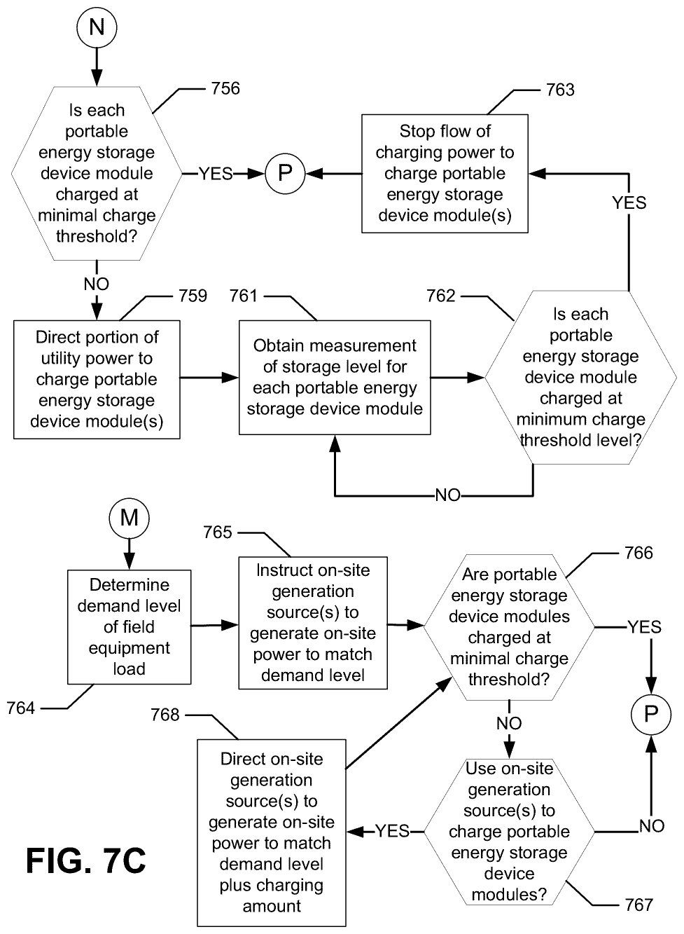

The control engine 506 of the controller 304 can communicate with one or more other components of the system 300. For example, the control engine 506 can use one or more protocols 532 to facilitate communication with the sensor devices 360 to obtain data (e.g., measurements of various parameters, such as voltage, current, electrical demand, electrical usage, temperature, humidity), whether in real time or on a periodic basis and/or to instruct a sensor device 360 to take a measurement. A number of these and other capabilities of the control engine 506 (as well as the controller 304 as a whole) are discussed below with respect to FIGS. 7A through 7C.

The control engine 506 can generate and process data associated with control, communication, and/or other signals sent to and obtained from the users 351 (including associated user systems 355), the sensor devices 360, the network manager 380, and the other components of the system 300. In certain embodiments, the control engine 506 of the controller 304 can communicate with one or more components of a system external to the system 300. For example, the control engine 506 can interact with an inventory management system by ordering replacements for components or pieces of equipment (e.g., a sensor device 360, a valve, a motor) within the system 300 that has failed or is failing. As another example, the control engine 506 can interact with a contractor or workforce scheduling system by arranging for the labor needed to replace a component or piece of equipment in the system 300. In this way and in other ways, the controller 304 is capable of performing a number of functions beyond what could reasonably be considered a routine task.

In certain example embodiments, the control engine 506 can include an interface that enables the control engine 506 to communicate with the sensor devices 360, the user systems 355, the network manager 380, and/or other components of the system 300. For example, if a user system 355 operates under IEC Standard 62386, then the user system 355 can have a serial communication interface that will transfer data to the controller 304. Such an interface can operate in conjunction with, or independently of, the protocols 532 used to communicate between the controller 304 and the users 351 (including corresponding user systems 355), the sensor devices 360, the network manager 380, and the other components of the system 300.

The control engine 506 (or other components of the controller 304) can also include one or more hardware components and/or software elements to perform its functions. Such components can include, but are not limited to, a universal asynchronous receiver/transmitter (UART), a serial peripheral interface (SPI), a direct-attached capacity (DAC) storage device, an analog-to-digital converter, an inter-integrated circuit (I²C), and a pulse width modulator (PWM).

The analysis module 550 of the controller 304 can be configured to compare the measurements (e.g., as measured by one or more of the sensor devices 360) of the various parameters associated with the portable energy storage device modules 385, the on-site substation 375, the utility power sources 345, the field equipment load 390, and the on-site generation sources 340. The comparisons made by the analysis module 550 can be performed using the control engine 506 in combination with one or more protocols 532 and/or one or more algorithms 533. The comparisons made by the analysis module 550 can include tables generated and maintained by the analysis module 550.

The analysis module 550 can further be configured to determine, using the control engine 506 in combination with one or more protocols 532 and/or one or more algorithms 533, how actual performance of the various components (e.g., the portable energy storage device modules 385, the on-site substation 375, the utility power sources 345, the field equipment load 390, the on-site generation sources 340) of the system 300 compares to forecast performance of those components. To the extent that differences exist between actual and forecast performance, the analysis module 550 can make the appropriate adjustments to stored data 534 (e.g., reorganize tables), one or more of the protocols 532, and/or one or more of the algorithms 533 to make future forecasts more accurate.

The analysis module 550 can use any of a number of techniques, protocols 532, algorithms 533, and/or other methods for performing its functions. Such methods can be used to balance a number of goals, such as reducing data, improved accuracy, and performing efficient correlations and pattern finding. Examples of such methods can include, but are not limited to, principal component analysis (PCA), restricted isometry constant (RIC) statistical method, risk management index (RMI) statistical method, artificial intelligence (AI) approaches, and machine learning/deep learning approaches.

The communication module 507 of the controller 304 determines and implements the communication protocol (e.g., from the protocols 532 of the storage repository 531) that is used when the control engine 506 communicates with (e.g., sends signals to, obtains signals from) the user systems 355, the sensor devices 360, the network manager 380, and the other components of the system 300. In some cases, the communication module 507 accesses the stored data 534 to determine which communication protocol is used to communicate with another component of the system 300. In addition, the communication module 507 can identify and/or interpret the communication protocol of a communication obtained by the controller 304 so that the control engine 506 can interpret the communication. The communication module 507 can also provide one or more of a number of other services with respect to data sent from and obtained by the controller 304. Such services can include, but are not limited to, data packet routing information and procedures to follow in the event of data interruption.

The timer 535 of the controller 304 can track clock time, intervals of time, an amount of time, and/or any other measure of time. The timer 535 can also count the number of occurrences of an event, whether with or without respect to time. Alternatively, the control engine 506 can perform a counting function. The timer 535 is able to track multiple time measurements and/or count multiple occurrences concurrently. The timer 535 can track time periods based on an Instruction obtained from the control engine 506, based on an instruction obtained from a user 351, based on an instruction programmed in the software for the controller 304, based on some other condition (e.g., the occurrence of an event) or from some other component, or from any combination thereof. In certain example embodiments, the timer 535 can provide a time stamp for each packet of data obtained from another component (e.g., a sensor device 360) of the system 300.

The power module 530 of the controller 304 obtains power from a power supply (e.g., AC mains) and manipulates (e.g., transforms, rectifies, inverts) that power to provide the manipulated power to one or more other components (e.g., the timer 535, the control engine 506) of the controller 304, where the manipulated power is of a type (e.g., alternating current, direct current) and level (e.g., 12V, 24V, 120V) that can be used by the other components of the controller 304. In some cases, the power module 530 can also provide power to one or more of the sensor devices 360.

The power module 530 can include one or more of a number of single or multiple discrete components (e.g., transistor, diode, resistor, transformer) and/or a microprocessor. The power module 530 may include a printed circuit board, upon which the microprocessor and/or one or more discrete components are positioned. In addition, or in the alternative, the power module 530 can be a source of power in itself to provide signals to the other components of the controller 304. For example, the power module 530 can be or include an energy storage device (e.g., a battery). As another example, the power module 530 can be or include a localized photovoltaic power system.

The hardware processor 521 of the controller 304 executes software, algorithms (e.g., algorithms 533), and firmware in accordance with one or more example embodiments. Specifically, the hardware processor 521 can execute software on the control engine 506 or any other portion of the controller 304, as well as software used by the users 351 (including associated user systems 355), the network manager 380, and/or other components of the system 300. The hardware processor 521 can be an integrated circuit, a central processing unit, a multi-core processing chip, SoC, a multi-chip module including multiple multi-core processing chips, or other hardware processor in one or more example embodiments. The hardware processor 521 can be known by other names, including but not limited to a computer processor, a microprocessor, and a multi-core processor.

In one or more example embodiments, the hardware processor 521 executes software instructions stored in memory 522. The memory 522 includes one or more cache memories, main memory, and/or any other suitable type of memory. The memory 522 can include volatile and/or non-volatile memory. The memory 522 can be discretely located within the controller 304 relative to the hardware processor 521. In certain configurations, the memory 522 can be integrated with the hardware processor 521.

In certain example embodiments, the controller 304 does not include a hardware processor 521. In such a case, the controller 304 can include, as an example, one or more field programmable gate arrays (FPGA), one or more insulated-gate bipolar transistors (IGBTs), and/or one or more integrated circuits (ICs). Using FPGAs, IGBTs, ICs, and/or other similar devices known in the art allows the controller 304 (or portions thereof) to be programmable and function according to certain logic rules and thresholds without the use of a hardware processor. Alternatively, FPGAs, IGBTs, ICs, and/or similar devices can be used in conjunction with one or more hardware processors 521.

The transceiver 524 of the controller 304 can send and/or obtain control and/or communication signals. Specifically, the transceiver 524 can be used to transfer data between the controller 304 and the users 351 (including associated user systems 355), the sensor devices 360, the network manager 380, and the other components of the system 300. The transceiver 524 can use wired and/or wireless technology. The transceiver 524 can be configured in such a way that the control and/or communication signals sent and/or obtained by the transceiver 524 can be obtained and/or sent by another transceiver that is part of a user system 355, a sensor device 360, the network manager 380, and/or another component of the system 300. The transceiver 524 can send and/or obtain any of a number of signal types, including but not limited to radio frequency signals.

When the transceiver 524 uses wireless technology, any type of wireless technology can be used by the transceiver 524 in sending and obtaining signals. Such wireless technology can include, but is not limited to, Wi-Fi, Zigbee, VLC, cellular networking, BLE, UWB, and Bluetooth. The transceiver 524 can use one or more of any number of suitable communication protocols (e.g., ISA100, HART) when sending and/or obtaining signals.

Optionally, in one or more example embodiments, the security module 523 secures interactions between the controller 304, the users 351 (including associated user systems 355), the sensor devices 360, the network manager 380, and the other components of the system 300. More specifically, the security module 523 authenticates communication from software based on security keys verifying the identity of the source of the communication. For example, user software may be associated with a security key enabling the software of a user system 355 to interact with the controller 304. Further, the security module 523 can restrict receipt of information, requests for information, and/or access to information.

A user 351 (which may include an associated user system 355), the sensor devices 360, the network manager 380, and the other components of the system 300 can interact with the controller 304 using the application interface 526. Specifically, the application interface 526 of the controller 304 obtains data (e.g., information, communications, instructions, updates to firmware) from and sends data (e.g., information, communications, instructions) to the user systems 355 of the users 351, the sensor devices 360, the network manager 380, and/or the other components of the system 300. Examples of an application interface 526 can be or include, but are not limited to, an application programming interface, a web service, a data protocol adapter, some other hardware and/or software, or any suitable combination thereof. Similarly, the user systems 355 of the users 351, the sensor devices 360, the network manager 380, and/or the other components of the system 300 can include an interface (similar to the application interface 526 of the controller 304) to obtain data from and send data to the controller 304 in certain example embodiments.

In addition, as discussed above with respect to a user system 355 of a user 351, one or more of the sensor devices 360, the network manager 380, and/or one or more of the other components of the system 300 can include a user interface. Examples of such a user interface can include, but are not limited to, a graphical user interface, a touchscreen, a keyboard, a monitor, a mouse, some other hardware, or any suitable combination thereof.

The controller 304, the users 351 (including associated user systems 355), the sensor devices 360, the network manager 380, and the other components of the system 300 can use their own system or share a system in certain example embodiments. Such a system can be, or contain a form of, an Internet-based or an intranet-based computer system that is capable of communicating with various software. A computer system includes any type of computing device and/or communication device, including but not limited to the controller 304. Examples of such a system can include, but are not limited to, a desktop computer with a Local Area Network (LAN), a Wide Area Network (WAN), Internet or intranet access, a laptop computer with LAN, WAN, Internet or intranet access, a smart phone, a server, a server farm, an android device (or equivalent), a tablet, smartphones, and a personal digital assistant (PDA). Such a system can correspond to a computer system as described below with regard to FIG. 6.

Further, as discussed above, such a system can have corresponding software (e.g., user system software, sensor device software, controller software). The software can execute on the same or a separate device (e.g., a server, mainframe, desktop personal computer (PC), laptop, PDA, television, cable box, satellite box, kiosk, telephone, mobile phone, or other computing devices) and can be coupled by the communication network (e.g., Internet, Intranet, Extranet, LAN, WAN, or other network communication methods) and/or communication channels, with wire and/or wireless segments according to some example embodiments. The software of one system can be a part of, or operate separately but in conjunction with, the software of another system within the system 300.

FIG. 6 illustrates one embodiment of a computing device 618 that implements one or more of the various techniques described herein, and which is representative, in whole or in part, of the elements described herein pursuant to certain example embodiments. For example, a controller 404 (including components thereof, such as a control engine 506, a hardware processor 521, a storage repository 531, a power module 530, and a transceiver 524) can be considered a computing device 618 (also called a computer system 618 herein). Computing device 618 is one example of a computing device and is not intended to suggest any limitation as to scope of use or functionality of the computing device and/or its possible architectures. Neither should the computing device 618 be interpreted as having any dependency or requirement relating to any one or combination of components illustrated in the example computing device 618.

The computing device 618 includes one or more processors or processing units 614, one or more memory/storage components 615, one or more input/output (I/O) devices 616, and a bus 617 that allows the various components and devices to communicate with one another. The bus 617 represents one or more of any of several types of bus structures, including a memory bus or memory controller, a peripheral bus, an accelerated graphics port, and a processor or local bus using any of a variety of bus architectures. The bus 617 includes wired and/or wireless buses.

The memory/storage component 615 represents one or more computer storage media. The memory/storage component 615 includes volatile media (such as random access memory (RAM)) and/or nonvolatile media (such as read only memory (ROM), flash memory, optical disks, magnetic disks, and so forth). The memory/storage component 615 includes fixed media (e.g., RAM, ROM, a fixed hard drive, etc.) as well as removable media (e.g., a Flash memory drive, a removable hard drive, an optical disk, and so forth).

One or more I/O devices 616 allow a user 351 to enter commands and information to the computing device 618, and also allow information to be presented to the user 351 and/or other components or devices. Examples of input devices 616 include, but are not limited to, a keyboard, a cursor control device (e.g., a mouse), a microphone, a touchscreen, and a scanner. Examples of output devices include, but are not limited to, a display device (e.g., a monitor or projector), speakers, outputs to a lighting network (e.g., DMX card), a printer, and a network card.

Various techniques are described herein in the general context of software or program modules. Generally, software includes routines, programs, objects, components, data structures, and so forth that perform particular tasks or implement particular abstract data types. An implementation of these modules and techniques are stored on or transmitted across some form of computer readable media. Computer readable media is any available non-transitory medium or non-transitory media that is accessible by a computing device. By way of example, and not limitation, computer readable media includes “computer storage media”.

“Computer storage media” and “computer readable medium” include volatile and non-volatile, removable and non-removable media implemented in any method or technology for storage of information such as computer readable instructions, data structures, program modules, or other data. Computer storage media include, but are not limited to, computer recordable media such as RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which is used to store the desired information and which is accessible by a computer.

The computer device 618 is connected to a network (not shown) (e.g., a LAN, a WAN such as the Internet, cloud, or any other similar type of network) via a network interface connection (not shown) according to some example embodiments. Those skilled in the art will appreciate that many different types of computer systems exist (e.g., desktop computer, a laptop computer, a personal media device, a mobile device, such as a cell phone or personal digital assistant, or any other computing system capable of executing computer readable instructions), and the aforementioned input and output means take other forms, now known or later developed, in other example embodiments. Generally speaking, the computer system 618 includes at least the minimal processing, input, and/or output means necessary to practice one or more embodiments.

Further, those skilled in the art will appreciate that one or more elements of the aforementioned computer device 618 is located at a remote location and connected to the other elements over a network in certain example embodiments. Further, one or more embodiments is implemented on a distributed system having one or more nodes, where each portion of the implementation (e.g., the portable energy storage device modules 385, the on-site substation 375, the utility power sources 345, the field equipment load 390, the on-site generation sources 340) is located on a different node within the distributed system. In one or more embodiments, the node corresponds to a computer system. Alternatively, the node corresponds to a processor with associated physical memory in some example embodiments. The node alternatively corresponds to a processor with shared memory and/or resources in some example embodiments.

FIGS. 7A through 7C show a flowchart 758 of a method for providing power to field equipment for subterranean field operations according to certain example embodiments. While the various steps in this flowchart 758 are presented sequentially, one of ordinary skill will appreciate that some or all of the steps may be executed in different orders, may be combined or omitted, and some or all of the steps may be executed in parallel. Further, in one or more of the example embodiments, one or more of the steps shown in this example method may be omitted, repeated, and/or performed in a different order. Some or all of the steps of the method of FIGS. 7A through 7C can be performed off site (e.g., in a laboratory remote from a field operation). In addition, or in the alternative, some or all of the steps of the method of FIGS. 7A through 7C can be performed on site (e.g., in the field, adjacent to a wellbore 120) where a field operation is being performed or planned.

In addition, a person of ordinary skill in the art will appreciate that additional steps not shown in FIGS. 7A through 7C may be included in performing this method. Accordingly, the specific arrangement of steps should not be construed as limiting the scope. Further, a particular computing device, such as the computing device 618 discussed above with respect to FIG. 6, can be used to perform one or more of the steps for the methods shown in FIGS. 7A through 7C in certain example embodiments. Any of the functions performed below by a controller 304 (an example of which is discussed above with respect to FIG. 5) can involve the use of one or more protocols 532, one or more algorithms 533, and/or stored data 534 stored in a storage repository 531. In addition, or in the alternative, any of the functions in the method can be performed by a user (e.g., user 351).

The method shown in FIGS. 7A through 7C is merely an example that can be performed by using an example system described herein. In other words, systems for providing power to field equipment for subterranean field operations can perform other functions using other methods in addition to and/or aside from those shown in FIGS. 7A through 7C. Referring to FIGS. 1 through 7C, the method shown in the flowchart 758 of FIGS. 7A through 7C begins at the START step and proceeds to step 781, where a measurement of the utility power 352 provided by the utility power source 345 is obtained. As used herein, the term “obtaining” may include receiving, retrieving, accessing, generating, etc. or any other manner of obtaining the measurement.

The measurement can be one or more measurements made by one or more sensor devices 360 for one or more parameters that are associated with the amount of utility power 352 provided by the utility power source 345. Some or all of the measurements can be obtained using a controller 304 (or an obtaining component thereof) using one or more algorithms 533 and/or one or more protocols 532. In addition, or in the alternative, some or all of the measurements can be obtained from, or with the assistance of, a user 351, including an associated user system 355.

In step 782, a determination is made as to whether the utility power 352 is greater than zero. In other words, a determination is made as to whether the utility power source 345 has tripped, is in an outage, or is otherwise unavailable. The determination can be made by a controller 304 (or the analysis module 550 thereof) using one or more algorithms 533, one or more protocols 532, the measurements of step 781, input from a user 351 (which can include an associated user system 355), some other source of information, or any suitable combination thereof. If the utility power 352 is greater than zero, then the process proceeds to step 783. If the utility power 352 is not greater than zero, then the process proceeds to step 711.

In step 711, a determination is made as to whether on-site power 353 is available. To be available, one or more of the on-site power generation sources 340 must exist (are not optional) and must be available for use. The determination can be made by a controller 304 (or the analysis module 550 thereof) using one or more algorithms 533, one or more protocols 532, the measurements made by one or more of the sensor devices 360, input from a user 351 (which can include an associated user system 355), some other source of information, or any suitable combination thereof. If the on-site power 353 is available, then the process proceeds to step 764. If the on-stie power 352 is not available, then the process proceeds to step 712.

In step 712, the field equipment load 390 is curtailed. In such a case, the field equipment load 390 can be completely curtailed. Alternatively, the field equipment load 390 can be curtailed to the extent that the remaining field equipment load 390 that is not curtailed can be powered by reserve power 358 provided by the portable energy storage device modules 385. The decision as to which of the field equipment load 390 to curtail can be made by a controller 304 (or a decision portion thereof) using one or more algorithms 533, one or more protocols 532, the measurements made by one or more of the sensor devices 360, input from a user 351 (which can include an associated user system 355), some other source of information, or any suitable combination thereof.

Further, the actual curtailment of the field equipment load 390 can be performed by a controller 304 (or a curtailment portion thereof) using one or more algorithms 533, one or more protocols 532, the measurements made by one or more of the sensor devices 360, input from a user 351 (which can include an associated user system 355), some other source of information, or any suitable combination thereof. If not all of the field equipment load 390 is curtailed initially, additional field equipment load 390 can be curtailed if the utility power 352 and the on-site power 353 continue to be unavailable as the amount of reserve power 358 is depleted. When step 712 is complete, the process proceeds to step 719.

In step 719, a determination is made as to whether field operations should continue. Ending field operations can be permanent or temporary. The determination can be made by a controller 304 (or a decision portion thereof) using one or more algorithms 533, one or more protocols 532, the measurements made by one or more of the sensor devices 360, input from a user 351 (which can include an associated user system 355), some other source of information, or any suitable combination thereof. If the field operations should continue, the process reverts to step 781. If the field operations should not continue, the process proceeds to the END step.

In step 764, the demand level of the field equipment load 390 is determined. The demand level of the field equipment load 390 can be instantaneous demand that is determined in real time. The demand level of the field equipment load 390 can be determined by a controller 304 (or the analysis module 550 thereof) using one or more algorithms 533, one or more protocols 532, the measurements made by one or more of the sensor devices 360, input from a user 351 (which can include an associated user system 355), some other source of information, or any suitable combination thereof.

In step 765, one or more of the on-site generation sources 340 are instructed to generate on-site power 353 to match the demand level of the field equipment load 390. The on-site power 353 generated by the on-site generation sources 340 can be manipulated (e.g., transformed, inverted) using an energy transfer device 443 of the on-site substation 375. The on-site generation sources 340 can be controlled by a controller 304 (or the control engine 506 thereof) using one or more algorithms 533, one or more protocols 532, the measurements made by one or more of the sensor devices 360, input from a user 351 (which can include an associated user system 355), some other source of information, or any suitable combination thereof. Similarly, the determination as to which of the on-site generation sources 340 to utilize, the level of output of each of the on-site generation sources 340, whether some of the field equipment load 390 should be curtailed, and/or other similar decisions can be made by a controller 304 (or the analysis module 550 thereof) using one or more algorithms 533, one or more protocols 532, the measurements made by one or more of the sensor devices 360, input from a user 351 (which can include an associated user system 355), some other source of information, or any suitable combination thereof.

In step 766, a determination is made as to whether the portable energy storage device modules 385 are charged at a minimum charge threshold level. The minimum charge threshold level is the minimum amount of storage that each of the portable energy storage device modules 385 requires before being able to release reserve power 358. The determination can be made as to individual energy storage devices within each portable energy storage device module 385 and/or between each of the portable energy storage device modules 385. The determination can be made by a controller 304 (or the analysis module 550 thereof) using one or more algorithms 533, one or more protocols 532, the measurements made by one or more of the sensor devices 360, input from a user 351 (which can include an associated user system 355), some other source of information, or any suitable combination thereof. If the portable energy storage device modules 385 are charged at a minimum charge threshold level, then the process reverts to step 719. If the portable energy storage device modules 385 are not charged at a minimum charge threshold level, then the process proceeds to step 767.

In step 767, a determination is made as to whether one or more of the on-site generation sources 340 should also be used to charge the portable energy storage device modules 385. The determination can be made based on one or more of a number of factors, including but not limited to economics, reliability, operational longevity, and logistics. The determination can be made by a controller 304 (or the analysis module 550 thereof) using one or more algorithms 533, one or more protocols 532, the measurements made by one or more of the sensor devices 360, input from a user 351 (which can include an associated user system 355), some other source of information, or any suitable combination thereof. If one or more of the on-site generation sources 340 should also be used to charge the portable energy storage device modules 385, then the process proceeds to step 768. If one or more of the on-site generation sources 340 should not be used to charge the portable energy storage device modules 385, then the process reverts to step 719.

In step 768, one or more of the on-site generation sources 340 are directed to generate on-site power 353 to match the demand level of the field equipment load 390 plus charging power 357 to charge the portable energy storage device modules 385. The on-site power 353 generated by the on-site generation sources 340 can be manipulated (e.g., transformed, inverted) using an energy transfer device 443 of the on-site substation 375. The on-site generation sources 340 can be controlled by a controller 304 (or the control engine 506 thereof) using one or more algorithms 533, one or more protocols 532, the measurements made by one or more of the sensor devices 360, input from a user 351 (which can include an associated user system 355), some other source of information, or any suitable combination thereof. Similarly, the determination as to which of the on-site generation sources 340 to utilize, the level of output of each of the on-site generation sources 340, whether some of the field equipment load 390 should be curtailed, and/or other similar decisions can be made by a controller 304 (or the analysis module 550 thereof) using one or more algorithms 533, one or more protocols 532, the measurements made by one or more of the sensor devices 360, input from a user 351 (which can include an associated user system 355), some other source of information, or any suitable combination thereof. When step 768 is complete, the process can revert to step 766.

In step 783, the demand level of the field equipment load 390 is determined. The demand level of the field equipment load 390 can be instantaneous demand that is determined in real time. The demand level of the field equipment load 390 can be determined by a controller 304 (or the analysis module 550 thereof) using one or more algorithms 533, one or more protocols 532, the measurements made by one or more of the sensor devices 360, input from a user 351 (which can include an associated user system 355), some other source of information, or any suitable combination thereof.

In step 784, a determination is made as to whether the demand level of the field equipment load 390 exceeds the utility power setpoint value of the utility power source 345. In other words, a determination is made as to whether the current demand of the field equipment load 390 is greater than what the utility power source 345 can safely and reliably provide. The determination can be made by a controller 304 (or the analysis module 550 thereof) using one or more algorithms 533, one or more protocols 532, the measurements made by one or more of the sensor devices 360, input from a user 351 (which can include an associated user system 355), some other source of information, or any suitable combination thereof. If the demand level of the field equipment load 390 exceeds the utility power setpoint value of the utility power source 345, then the process proceeds to step 736. If the demand level of the field equipment load 390 does not exceed the utility power setpoint value of the utility power source 345, then the process proceeds to step 756.

In step 736, a determination is made as to whether one of the portable energy storage device modules 385 is charged to the minimal storage level. The minimum storage level of a portable energy storage device module 385 is the minimal level of charging required for the portable energy storage device module 385 to provide reserve power 358. The determination can be made by a controller 304 (or the analysis module 550 thereof) using one or more algorithms 533, one or more protocols 532, the measurements made by one or more of the sensor devices 360, input from a user 351 (which can include an associated user system 355), some other source of information, or any suitable combination thereof. If the portable energy storage device module 385 is charged to the minimal storage level, then the process proceeds to step 737. If the portable energy storage device module 385 is not charged to the minimal storage level, then the process proceeds to step 744.

In step 737, the portable energy storage device module 385 is instructed to release reserve power 358. The reserve power 358 released by the portable energy storage device module 385 can be manipulated (e.g., converted) using an energy transfer device 443 of the on-site substation 375. The portable energy storage device module 385 can be controlled by a controller 304 (or the control engine 506 thereof) using one or more algorithms 533, one or more protocols 532, the measurements made by one or more of the sensor devices 360, input from a user 351 (which can include an associated user system 355), some other source of information, or any suitable combination thereof.

In step 738, a determination is made as to whether the amount of the reserve power 358 provided by the portable energy storage device module 385 is greater than the difference between the demand level of the field equipment load 390 and the utility power setpoint value. In other words, a determination is made as to whether the amount of the reserve power 358 provided by the portable energy storage device module 385 is sufficient to shave the peak of the field equipment load 390. The determination can be made by a controller 304 (or the analysis module 550 thereof) using one or more algorithms 533, one or more protocols 532, the measurements made by one or more of the sensor devices 360, input from a user 351 (which can include an associated user system 355), some other source of information, or any suitable combination thereof. If the amount of the reserve power 358 provided by the portable energy storage device module 385 is greater than the difference between the demand level of the field equipment load 390 and the utility power setpoint value, then the process proceeds to step 739. If the amount of the reserve power 358 provided by the portable energy storage device module 385 is not greater than the difference between the demand level of the field equipment load 390 and the utility power setpoint value, then the process proceeds to step 744.

In step 739, a measurement of the reserve power 358 is obtained. The measurement can be one or more measurements made by one or more sensor devices 360 for one or more parameters that are associated with the amount of reserve power 358 provided by the portable energy storage device module 385. Some or all of the measurements can be obtained using a controller 304 (or an obtaining component thereof) using one or more algorithms 533 and/or one or more protocols 532. In addition, or in the alternative, some or all of the measurements can be obtained from, or with the assistance of, a user 351, including an associated user system 355. When step 739 is complete, the process can revert to step 719.

In step 744, a determination is made as to whether an additional portable energy storage device module 385 is available. The additional portable energy storage device module 385 can be located on site but is not currently being utilized. In addition, or in the alternative, the additional portable energy storage device module 385 can be brought to the site of the field operations for future use. The determination can be made by a controller 304 (or the analysis module 550 thereof) using one or more algorithms 533, one or more protocols 532, the measurements made by one or more of the sensor devices 360, input from a user 351 (which can include an associated user system 355), some other source of information, or any suitable combination thereof. If there is an additional portable energy storage device module 385 available, then the process reverts to step 736. If there is not an additional portable energy storage device module 385 available, then the process proceeds to step 746.

In step 746, a determination is made as to whether on-site power 353 is available. To be available, one or more of the on-site power generation sources 340 must exist (are not optional) and must be available for use. The determination can be made by a controller 304 (or the analysis module 550 thereof) using one or more algorithms 533, one or more protocols 532, the measurements made by one or more of the sensor devices 360, input from a user 351 (which can include an associated user system 355), some other source of information, or any suitable combination thereof. If the on-site power 353 is available, then the process proceeds to step 747. If the on-stie power 352 is not available, then the process proceeds to step 754.

In step 747, a determination is made as to whether one or more of the on-site generation sources 340 should also be used to charge the portable energy storage device modules 385. The determination can be made based on one or more of a number of factors, including but not limited to economics, reliability, operational longevity, and logistics. The determination can be made by a controller 304 (or the analysis module 550 thereof) using one or more algorithms 533, one or more protocols 532, the measurements made by one or more of the sensor devices 360, input from a user 351 (which can include an associated user system 355), some other source of information, or any suitable combination thereof. If one or more of the on-site generation sources 340 should also be used to charge the portable energy storage device modules 385, then the process proceeds to step 748. If one or more of the on-site generation sources 340 should not be used to charge the portable energy storage device modules 385, then the process proceeds to step 754.

In step 748, one or more of the on-site generation sources 340 are instructed to generate on-site power 353 to match the demand level of the field equipment load 390 less the amount of utility power 352 provided by the utility power sources 345 plus the amount of charging power 357 needed to charge the portable energy storage device modules 385. The on-site power 353 generated by the on-site generation sources 340 can be manipulated (e.g., transformed, inverted) using an energy transfer device 443 of the on-site substation 375 before being distributed. The on-site generation sources 340 can be controlled by a controller 304 (or the control engine 506 thereof) using one or more algorithms 533, one or more protocols 532, the measurements made by one or more of the sensor devices 360, input from a user 351 (which can include an associated user system 355), some other source of information, or any suitable combination thereof. Similarly, the determination as to which of the on-site generation sources 340 to utilize, the level of output of each of the on-site generation sources 340, whether some of the field equipment load 390 should be curtailed, and/or other similar decisions can be made by a controller 304 (or the analysis module 550 thereof) using one or more algorithms 533, one or more protocols 532, the measurements made by one or more of the sensor devices 360, input from a user 351 (which can include an associated user system 355), some other source of information, or any suitable combination thereof.

In step 749, a determination is made as to whether the portable energy storage device modules 385 are charged at a minimum charge threshold level. As discussed above, the minimum charge threshold level is the minimum amount of charge or storage that each of the portable energy storage device modules 385 requires before being able to release reserve power 358. The determination can be made as to individual energy storage devices within each portable energy storage device module 385 and/or between each of the portable energy storage device modules 385. The determination can be made by a controller 304 (or the analysis module 550 thereof) using one or more algorithms 533, one or more protocols 532, the measurements made by one or more of the sensor devices 360, input from a user 351 (which can include an associated user system 355), some other source of information, or any suitable combination thereof. If the portable energy storage device modules 385 are charged at a minimum charge threshold level, then the process reverts to step 719. If the portable energy storage device modules 385 are not charged at a minimum charge threshold level, then the process reverts to step 748.

In step 754, some of the field equipment load 390 is curtailed. Specifically, curtailment reduces the amount of demand of the field equipment load 390 to be no greater than the utility power setpoint value. This can be accomplished through a form of load-shedding, power-limiting, some other similar protocol, or any suitable combination thereof. The decision as to which of the field equipment load 390 to curtail can be made by a controller 304 (or a decision portion thereof) using one or more algorithms 533, one or more protocols 532, the measurements made by one or more of the sensor devices 360, input from a user 351 (which can include an associated user system 355), some other source of information, or any suitable combination thereof. When step 754 is complete, the process can revert to step 719.

In step 756, a determination is made as to whether the portable energy storage device modules 385 are charged at a minimum charge threshold level. As discussed above, the minimum charge threshold level is the minimum amount of charge or storage that each of the portable energy storage device modules 385 requires before being able to release reserve power 358. The determination can be made as to individual energy storage devices within each portable energy storage device module 385 and/or between each of the portable energy storage device modules 385. The determination can be made by a controller 304 (or the analysis module 550 thereof) using one or more algorithms 533, one or more protocols 532, the measurements made by one or more of the sensor devices 360, input from a user 351 (which can include an associated user system 355), some other source of information, or any suitable combination thereof. If the portable energy storage device modules 385 are charged at a minimum charge threshold level, then the process reverts to step 719. If the portable energy storage device modules 385 are not charged at a minimum charge threshold level, then the process proceeds to step 759.

In step 759, a portion of the utility power 352 is directed to charge the portable energy storage device modules 385 as charging power 357. The utility power 352 provided by the utility power source 345 can be manipulated (e.g., transformed, inverted) using an energy transfer device 443 of the on-site substation 375 before being delivered to the portable energy storage device modules 385 as charging power 357. The amount of utility power 352 received from the utility power source 345 can be controlled by a controller 304 (or the control engine 506 thereof) using one or more algorithms 533, one or more protocols 532, the measurements made by one or more of the sensor devices 360, input from a user 351 (which can include an associated user system 355), some other source of information, or any suitable combination thereof. Similarly, the determination as to how much charging power 357 to deliver to the portable energy storage device modules 385 and which of the portable energy storage device modules 385 should receive the charging power 357 can be made by a controller 304 (or the analysis module 550 thereof) using one or more algorithms 533, one or more protocols 532, the measurements made by one or more of the sensor devices 360, input from a user 351 (which can include an associated user system 355), some other source of information, or any suitable combination thereof. When step 759 is complete, the process proceeds to step 761.

In step 761, a measurement of the storage level of each of the portable energy storage device modules 385 is obtained. The measurement can be one or more measurements made by one or more sensor devices 360 for one or more parameters that are associated with the amount of charge (which translates to the amount of reserve power 358) for each portable energy storage device module 385. Some or all of the measurements can be obtained using a controller 304 (or an obtaining component thereof) using one or more algorithms 533 and/or one or more protocols 532. In addition, or in the alternative, some or all of the measurements can be obtained from, or with the assistance of, a user 351, including an associated user system 355.

In step 762, a determination is made as to whether the portable energy storage device modules 385 are charged at a minimum charge threshold level. As discussed above, the minimum charge threshold level is the minimum storage level that each of the portable energy storage device modules 385 requires before being able to release reserve power 358. The determination can be made as to individual energy storage devices within each portable energy storage device module 385 and/or between each of the portable energy storage device modules 385. The determination can be made by a controller 304 (or the analysis module 550 thereof) using one or more algorithms 533, one or more protocols 532, the measurements made by one or more of the sensor devices 360, input from a user 351 (which can include an associated user system 355), some other source of information, or any suitable combination thereof. If the portable energy storage device modules 385 are charged at a minimum charge threshold level, then the process proceeds to step 763. If the portable energy storage device modules 385 are not charged at a minimum charge threshold level, then the process reverts to step 761.

In step 763, the flow of charging power 357 directed to the portable energy storage device modules 385 is stopped. In this case, the flow of charging power 357 is stopped by reducing the amount of utility power 352 provided by the utility power source 345. The amount of utility power 352 received from the utility power source 345 can be controlled by a controller 304 (or the control engine 506 thereof) using one or more algorithms 533, one or more protocols 532, the measurements made by one or more of the sensor devices 360, input from a user 351 (which can include an associated user system 355), some other source of information, or any suitable combination thereof.

In some cases, the amount of charging power 357 delivered to the portable energy storage device modules 385 can be reduced (rather than entirely stopped), as when one or more of the portable energy storage device modules 385 is completely charged, but one or more of the other portable energy storage device modules 385 has not yet reached the minimum charging threshold. In such a case, the determination as to how much charging power 357 to deliver to the portable energy storage device modules 385 and which of the portable energy storage device modules 385 should receive the charging power 357 can be made by a controller 304 (or the analysis module 550 thereof) using one or more algorithms 533, one or more protocols 532, the measurements made by one or more of the sensor devices 360, input from a user 351 (which can include an associated user system 355), some other source of information, or any suitable combination thereof. When step 763 is complete, the process can revert to step 719.

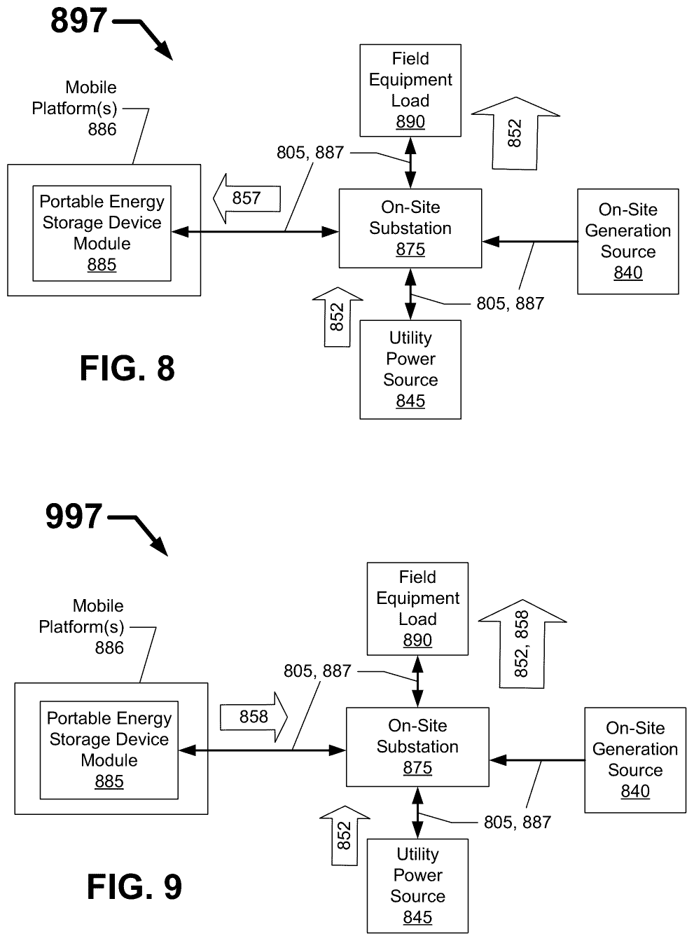

FIGS. 8 through 11 show power flow diagrams according to certain example embodiments. Referring to FIGS. 1 through 11, the power flow diagrams of FIGS. 8 through 11 include power transfer links 887, communication links 805, a portable energy storage device module 885 mounted on a mobile platform 886, an on-site substation 875, a utility power source 845, field equipment load 890, and an on-site generation source 840. These components are substantially the same as the power transfer links 387, the communication links 305, the portable energy storage device modules 385, the mobile platforms 386, the on-site substation 375, the utility power sources 345, the field equipment load 390, and the on-site generation sources 340 discussed above.

At the point in time captured in by the diagram 897 of FIG. 8, the on-site generation source 840 is not being used, and so the on-site generation source 840 is not providing any on-site power (e.g., on-site power 353). The field equipment load 890 is 0.5 MW. The energy storage devices of the portable energy storage device module 885 are not charged enough to provide reserve power (e.g., reserve power 358). In this case, the portable energy storage device module 885 can receive up to 0.75 MW of charging power 857. The utility power source 845 is configured to reliably deliver up to 2.3 MW of power to the on-site substation 875.

In other words, at the point in time captured in by the diagram 897 of FIG. 8, the utility power source 845 can provide utility power 852 in an amount that meets the entire needs of the field equipment load 890 while also charging the portable energy storage device module 885. For example, the utility power source 845 can deliver approximately 1.25 MW of utility power 852 to the on-site substation 875 at the time captured in FIG. 8. Substantially instantaneously, the on-site substation 875 uses approximately 60% of the utility power 852 to generate and deliver approximately 0.75 MW of charging power 857 to the portable energy storage device module 885. Simultaneously, the on-site substation 875 uses the remaining approximately 40% of the utility power 852 to generate and deliver approximately 0.5 MW of utility power 852 to the field equipment load 890. In this way, the real-time demand of the field equipment load 890 is reliably served by the utility power source 845, and the energy storage devices of the portable energy storage device module 885 can be charged so that the portable energy storage device module 885 can provide reserve power in the future.

In this particular example, the utility power setpoint value is 2.3 MW, which is higher than the average demand of the field equipment load 890. The energy storage devices of the portable energy storage device module 885 include lithium ion batteries that have a rating of 1500 kWh. With this battery rating, during periods of peak demand of the field equipment load 890, 100 kWh of energy is normally the maximum required during a 15 minute interval, which is the average amount of time that the peak demand of the field equipment load 890 lasts. In cases where the peak demand of the field equipment load 890 lasts longer than average, the rating of the batteries allows for approximately one hour of discharge. Example embodiments provide for a large enough capacity of the energy storage devices (e.g., a sufficient number of energy storage devices, energy storage devices having sufficient charging capacity) to accomplish the goals described herein.

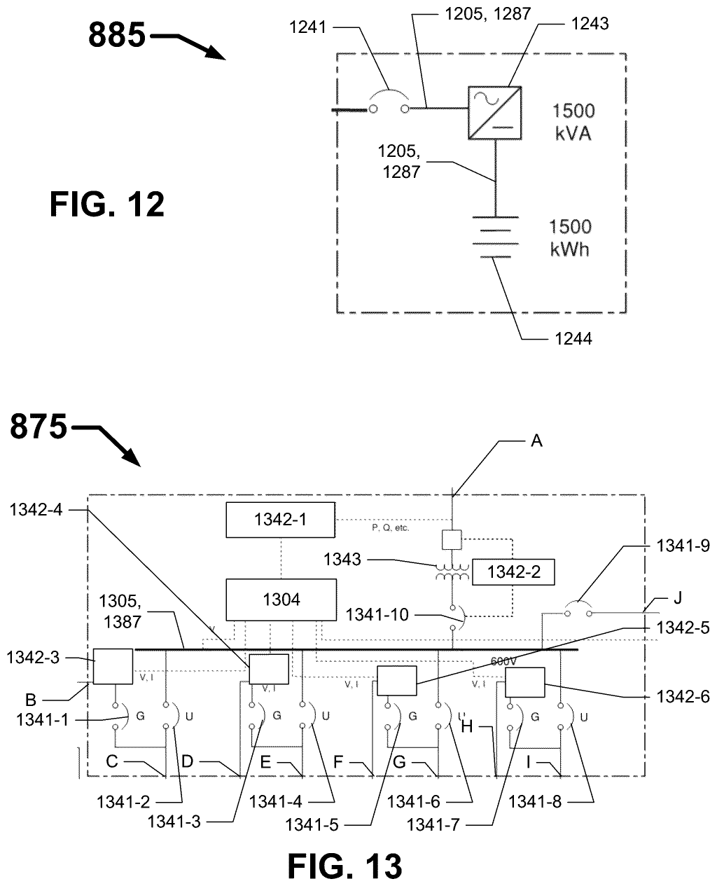

Further, the on-site substation 875 can control the on-site generation source 840 to provide charging power 857 to the portable energy storage device module 885 when the storage level of the energy storage devices of the portable energy storage device module 885 reach some level (e.g., approximately 50%). The portable energy storage device module 885 can also include an inverter with a rating of 1500 kVA, which can supply up to 1800 kW for a short period of time. The size of this inverter can provide for up to the approximately 1.4 MW of peak demand that might be called on from the portable energy storage device module 885. The portable energy storage device module 885 can also include a breaker (e.g., similar to a breaker 441). A schematic diagram of the portable energy storage device module 885 is shown below with respect to FIG. 12. A schematic diagram of the on-site substation 875 is shown below with respect to FIG. 13. The on-site generation source 840 in this case includes four diesel engine gensets rated at 991 kW each.

At the point in time captured in by the diagram 997 of FIG. 9, the on-site generation source 840 is still not being used, and so the on-site generation source 840 is still not providing any on-site power (e.g., on-site power 353). The field equipment load 890 has increased to 3.7 MW. This level of demand of the field equipment load 890 exceeds the 2.3 MW maximum limit that can be provided by the utility power source 845. Without an additional source of power to provide to the field equipment load 890, the on-site substation 875 would be forced to curtail some of the field equipment load 890 so that the utility power source 845 does not trip and go offline.

The on-site substation 875 has three options to find additional power to provide to the field equipment load 890 as a supplement to the utility power 852. One option is to control the on-site generation source 840 to generate 1.4 MW of on-site power (e.g., on-site power 353). The other option is to control the portable energy storage device module 885 to release and deliver 1.4 MW of reserve power 858. The third option is to control the on-site generation source 840 and the portable energy storage device module 885 to deliver, in combination, a total of 1.4 MW. Implementation of the second and third options are based on whether the energy storage devices of the portable energy storage device module 885 are charged enough so that the portable energy storage device module 885 can provide sufficient reserve power 858.

In this case, the energy storage devices of the portable energy storage device module 885 are now charged enough to provide reserve power 858 equal to approximately 1.4 MW. In this way, the on-site substation 875 provides, using 2.3 MW of utility power 852 from the utility power source 845 and 1.4 MW of reserve power 858 from the portable energy storage device module 885, all of the demand needs of the field equipment load 890 at the time captured by FIG. 9 without having to curtail any of the field equipment load 890 and without causing the utility power source 845 to trip or otherwise fail. In cases were the field equipment load 890 is at peak demand, as in this case, the time that the field equipment load 890 remains at peak demand can be limited (e.g., 5 minutes, 30 minutes) but not instantaneous.

At the point in time captured in by the diagram 1097 of FIG. 10, the field equipment load 890 remains at 3.7 MW. However, the level of charge of the energy storage devices of the portable energy storage device module 885 have fallen below a threshold level, requiring the energy storage devices of the portable energy storage device module 885 to receive charging power 857 rather than provide reserve power (e.g., reserve power 858). Since the utility power source 845 is still configured to reliably deliver up to 2.3 MW of power to the on-site substation 875, the remaining 1.4 MW of power required by the field equipment load 890 must come from the on-site generation source 840. Otherwise, the on-site substation 875 must curtail at least 1.4 MW of the field equipment load 890.

In this case, the on-site substation 875 controls the on-site generation source 840 to deliver 1.8 MW of on-site power 853. When the on-site substation 875 receives the 1.8 MW from the on-site generation source 840, it directs 1.4 MW to the field equipment load 890 as on-site power 853, and the remaining 0.4 MW is delivered (after sufficient energy transformation) to the portable energy storage device module 885 as charging power 857. Under this operating scheme, the on-site substation 875 provides, using 2.3 MW of utility power 852 from the utility power source 845 and 1.4 MW of on-site power 853 from the on-site generation source 840, all of the demand needs of the field equipment load 890 at the time captured by FIG. 10 without having to curtail any of the field equipment load 890 and without causing the utility power source 845 to trip or otherwise fail. Also, the energy storage devices of the portable energy storage device module 885 receive charging power 857 so that the portable energy storage device module 885 can provide reserve power 858 to the on-site substation 875 at a future time.

The decision by the on-site substation 875 to operate the on-site generation source 845 to provide on-site power 853 rather than curtail some of the field equipment load 890 and to provide charging power 857 rather than let the energy storage devices of the portable energy storage device module 885 remain idle can be based on one or more of a number of factors. Such factors can include, but are not limited to, the cost of the fuel used by the on-site generation source 845, the availability of the fuel used by the on-site generation source 845, the amount of time remaining before the field equipment load 890 returns to a normal demand level, the amount of charge needed by the energy storage devices of the portable energy storage device module 885 before being able to provide reserve power 858, and the costs associated with curtailing parts of the field equipment load 890.

At the point in time captured in by the diagram 1197 of FIG. 11, the utility power source 845 is unavailable (e.g., tripped, is in planned outage, is in forced outage). Also, the energy storage devices of the portable energy storage device module 885 are not charged enough to provide reserve power (e.g., reserve power 858). As a result, the on-site generation source 840 is controlled by the on-site substation 875 to generate on-site power 853, which is used by both the field equipment load 890 (as on-site power 853) and by the portable energy storage device module 885 (as charging power 857).

At the point in time captured by FIG. 11, the field equipment load 890 is 1.5 MW. Based on the consideration of multiple factors (e.g., economic, reliability, environmental, equipment health, long-term goal attainment), the on-site substation 875 determines that the on-site generation source 840 should generate a total of 2.25 MW, of which 1.5 MW is delivered to the field equipment load 890 as on-site power 853 and 0.75 MW is delivered to the portable energy storage device module 885 as charging power 857.

FIG. 12 shows a schematic diagram of the portable energy storage device module 885 of FIGS. 8 through 11 according to certain example embodiments. Referring to FIGS. 1 through 12, the portable energy storage device module 885 of FIG. 12 includes a breaker 1241, an energy transfer device 1243, and an energy storage device 1244. As discussed above, the energy transfer device 1243 (similar to the energy transfer device 443 discussed above) of the portable energy storage device module 885 can be or include an inverter with a rating of 1500 kVA, which can supply up to 1800 kW for a short period of time. The size of this inverter can provide for up to the approximately 1.4 MW of peak demand that might be called on from the portable energy storage device module 885.

The breaker 1241 of the portable energy storage device module 885 can be substantially the same as the breaker 441 discussed above. The energy storage device 1244 in this case is a lithium ion battery set that is rated for 1500 kWh. The portable energy storage device module 885 also includes energy transfer links 1287 (substantially similar to the energy transfer links discussed above) and communication links 1205 (substantially similar to the communication links discussed above). The energy transfer links 1287 and the communication links 1205 are used to connect the breaker 1241, the energy transfer device 1243, and the energy storage device 1244 in series with each other. In certain example embodiments, the energy storage devices 1244 are designed to charge quickly, discharge high amounts of power (e.g., on the order of 1.7 MW) quickly, be used in hazardous environments, be mobile for use at multiple sites over time, and comply with applicable standards and regulations.

FIG. 13 shows a schematic diagram of the on-site substation 875 of FIGS. 8 through 11 according to certain example embodiments. Referring to FIGS. 1 through 13, the on-site substation 875 of FIG. 13 includes a controller 1304, ten breakers 1341 (breaker 1341-1, breaker 1341-2, breaker 1341-3, breaker 1341-4, breaker 1341-5, breaker 1341-6, breaker 1341-7, breaker 1341-8, breaker 1341-9, and breaker 1341-10), six relays 1342 (relay 1342-1, relay 1342-2, relay 1342-3, relay 1342-4, relay 1342-5, and relay 1342-6), an energy transfer device 1343, and 13 channels (channel A, channel B, channel C, channel D, channel E, channel F, channel G, channel H, channel I, and channel J). All of these components are interconnected to each other using power transfer links 1387 and communication links 1305. The controller 1304, the breakers 1341, the relays 1342, the power transfer links 1387, and the communication links 1305 of FIG. 13 can be substantially the same as the controllers, the breakers, the relays, the energy transfer devices, the power transfer links, and the communication links discussed above.

Channel A is configured to receive utility power (e.g., utility power 852) from the utility power source 845. The utility power travels through the energy transfer device 1343 (in this case, a transformer) and breaker 1341-10 to a busbar (part of the power transfer links 1387). From the busbar, the utility power can be distributed through breaker 1341-2 to channel C, breaker 1341-4 to channel E, breaker 1341-6 to channel G, or breaker 1341-8 to channel I to get to the field equipment load 890.

Channel B is configured to receive on-site power (e.g., on-site power 853) from one of the on-site generation sources 840, which travels through breaker 1341-2 to channel C to get to the field equipment load 890. Channel D is configured to receive on-site power from a second of the on-site generation sources 840, which travels through breaker 1341-4 to channel E to get to the field equipment load 890. Channel F is configured to receive on-site power from a third of the on-site generation sources 840, which travels through breaker 1341-5 to channel G to get to the field equipment load 890. Channel H is configured to receive on-site power from a fourth of the on-site generation sources 840, which travels through breaker 1341-6 to channel I to get to the field equipment load 890. Channel J is configured to send charging power (e.g., charging power 857) to and receive reserve power (e.g., reserve power 858) from the portable energy storage device modules 885 through breaker 1341-9.

Relay 1342-1 is a protective relay that is configured to provide overall monitoring protection for the on-site substation 875. Relay 1342-2 is a protective relay that is configured to provide monitoring protection with respect to the utility power. Relay 1342-3 is a protective relay that is configured to provide monitoring protection with respect to the first of the on-site generation sources 840. Relay 1342-4 is a protective relay that is configured to provide monitoring protection with respect to the second of the on-site generation sources 840. Relay 1342-4 is a protective relay that is configured to provide monitoring protection with respect to the third of the on-site generation sources 840. Relay 1342-5 is a protective relay that is configured to provide monitoring protection with respect to the fourth of the on-site generation sources 840. The controller 1304 is in communication with all of the relays 1342, as well as multiple sensor devices (e.g., sensor devices 360, not shown) and other components of the on-site substation 875.

Example embodiments can be used to provide peak shaving for sites conducting subterranean field operations where utility power is provided to the site. In such cases, the utility power has a limit (the utility power setpoint value) as to how much power can reliably be delivered. While the utility power setpoint value is sufficient to meet the electrical demand at the site during steady state operations, by the nature of the field operations, the steady state demand is occasionally exceeded for extended periods of time (e.g., 10 minutes, 30 minutes). These periods can require power in excess of the utility power setpoint value, and so example embodiments can provide the power needed to allow the field operations to continue without curtailment and to allow for the utility power setpoint value to avoid being exceeded. Example embodiments manage, in real time, the demand of the field equipment load, the utility power provided by the utility power source, the on-site power of any on-site generation, charging power to charge the portable energy storage device modules, and the reserve power provided by the portable energy storage device modules.

Example embodiments can be used to reduce operational risk and improve reliability of the field operations. Example embodiments can also extend the useful life of field equipment by providing sufficient power at all times. Example embodiments can provide a number of other benefits. Such other benefits can include, but are not limited to, optimizing well performance, ease of use, modularity, portability to other sites, flexibility to adapt based on changes in field operation stages, extending the life of a well, reducing damage to field equipment, configurability, and compliance with applicable industry standards and regulations.

Although embodiments described herein are made with reference to example embodiments, it should be appreciated by those skilled in the art that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the pre sent disclosure will suggest themselves to practitioners of the art. Therefore, the scope of the example embodiments is not limited herein.

What is claimed is:

1. A system for providing power to field equipment for subterranean field operations, the system comprising:
a utility power source that provides utility power, wherein the utility power has a setpoint value;
a portable energy storage device module configured to provide reserve power, wherein the portable energy storage device module is mounted on a movable platform;
an on-site substation that is configured to receive the utility power from the utility power source and the reserve power from the portable energy storage device module; and
a controller operably coupled to the on-site substation and the portable energy storage device module, wherein the controller is configured to:
determine, at a time, that a demand level of the field equipment exceeds the setpoint value;
control the portable energy storage device module to release the reserve power to the on-site substation; and
control the on-site substation to deliver the utility power at the setpoint value and the reserve power at a remaining level to the field equipment, wherein the setpoint value and the remaining level substantially equals the demand level of the field equipment.

2. The system of claim 1, further comprising:
a sensor device operably coupled to the controller, wherein the sensor device is configured to measure the demand level, the remaining level, and the setpoint value.

3. The system of claim 1, wherein the controller is further configured to:
determine, at a second time, that the demand level of the field equipment falls below the setpoint value; and
control the portable energy storage device module to retain the reserve power.

4. The system of claim 3, wherein the controller is further configured to:
determine, at a third time, that a storage level of the portable energy storage device module falls below a minimum discharge threshold value; and
control the on-site substation to deliver an excess amount of the utility power to the portable energy storage device module as charging power, wherein the excess amount, when added to the demand level of the field equipment at the third time, is no greater than the setpoint value.

5. The system of claim 4, wherein the controller is further configured to:
determine, at a fourth time, that a storage level of the portable energy storage device module reaches a maximum threshold value; and
control the on-site substation to stop delivering the charging power from the utility power to the portable energy storage device module.

6. The system of claim 1, further comprising:
an on-site generation source configured to provide on-site power to the on-site substation, wherein the controller is further configured to control the on-site substation to deliver a combination of the utility power and the on-site power at the demand level of the field equipment.

7. The system of claim 6, wherein the controller is further configured to:
determine, at a second time, that the demand level of the field equipment exceeds the setpoint value;
determine, at the second time, that an amount of storage of the portable energy storage device module falls below a minimum discharge threshold value;
control the on-site generation source to deliver the on-site power to the on-site substation;
control the portable energy storage device module to stop delivering the reserve power to the on-site substation; and
control the on-site substation to deliver a first portion of the on-site power to the field equipment and a second portion of the on-site power to the portable energy storage device module, wherein the first portion of the on-site power replaces the reserve power, and wherein the second portion of the on-site power serves as the charging power for the portable energy storage device module.

8. The system of claim 6, wherein the controller is further configured to:
determine that the demand level of the field equipment exceeds a sum of the utility power, the reserve power, and the on-site power that is available at a second time;
identify a non-critical portion of the field equipment during the second time;
control the field equipment to curtail the non-critical portion; and
control the on-site substation to deliver a curtailed level to the field equipment using at least one of a group consisting of the utility power, the reserve power, and the on-site power.

9. The system of claim 8, wherein the non-critical portion is curtailed using at least one of a group consisting of a fast load-shedding response and a power-limiting command.

10. The system of claim 6, wherein the controller is further configured to control the on-site substation to provide the excess amount to the portable energy storage device module as charging power using the on-site power generated by the on-site generation source.

11. The system of claim 1, further comprising:
an additional portable energy storage device module configured to receive the charging power, wherein the additional portable energy storage device module is further configured to generate, using the charging power, the reserve power.

12. The system of claim 1, wherein the controller is part of the on-site substation.

13. An on-site substation for providing power to field equipment for subterranean field operations, the on-site substation comprising:
a first channel configured to receive utility power from a utility power source;
a second channel configured to receive reserve power from a portable energy storage device module;
a third channel configured to deliver the utility power and the reserve power to the field equipment; and
a controller configured to:
determine, at a time, that a demand level of the field equipment exceeds a setpoint value of the utility power;
limit the utility power to the setpoint value;
deliver the utility power at the setpoint value to the field equipment through the third channel;
control the portable energy storage device module to deliver the reserve power at a remaining level to the second channel, wherein the setpoint value and the remaining level substantially equals the demand level of the field equipment; and
deliver the reserve power at the remaining level to the field equipment through the third channel.

14. The on-site substation of claim 13, further comprising:
a fourth channel configured to receive on-site power from an on-site generation source, wherein the controller is further configured to:
determine, at a second time, that an energy storage device of the portable energy storage device module has less than a minimum discharge threshold value; and
deliver the on-site power to the field equipment through the third channel, wherein the on-site power is of an amount that equals the remaining level.

15. The on-site substation of claim 14, wherein the controller is further configured to:
determine, at a third time, that the demand level of the field equipment is below the setpoint value;
control the on-site generation source to stop delivering the on-site power to the third channel;
direct a first portion of the utility power equal to the demand level to the field equipment through the first channel; and
direct a second portion of the utility power to the portable energy storage device module as charging power through the second channel.

16. The on-site substation of claim 15, wherein the controller is further configured to:
determine, at a fourth time, that the portable energy storage device module exceeds a maximum storage value;
direct the utility power equal to the demand level to the field equipment through the first channel; and
stop directing the charging power to the portable energy storage device module through the second channel.

17. The on-site substation of claim 13, further comprising:
an energy transfer device that manipulates the utility power between the first channel and the third channel;
a circuit breaker in line with the first channel and the third channel; and
a protective relay in line with the first channel and the third channel.

18. A method for providing power to field equipment for subterranean field operations, the method comprising:
determining, at a time, that a demand level of the field equipment exceeds a setpoint value of a utility generation source;
controlling a portable energy storage device module to release reserve power; and
controlling an on-site substation to deliver utility power from the utility generation source at the setpoint value and the reserve power at a remaining level to the field equipment, wherein the setpoint value and the remaining level substantially equals the demand level of the field equipment.

19. The method of claim 18, further comprising:
determining, at a second time, that an energy storage device of the portable energy storage device module has less than a minimum storage level; and
controlling the on-site substation to deliver on-site power to the field equipment in an amount that equals the remaining level.

20. The method of claim 18, further comprising:
determining, at a second time based on a measurement from a sensor device, that the setpoint value of the utility generation source has changed to a revised setpoint value; and
controlling the on-site substation to deliver utility power from the utility generation source at the revised setpoint value and the reserve power at a revised remaining level to the field equipment, wherein the revised setpoint value and the revised remaining level substantially equals the demand level of the field equipment.
